(19) United States
(12) Patent Application Publication
(10) Pub. No.: US 2008/0086417 A1
(43) Pub. Date: Apr. 10, 2008

(54) Payment abstraction layer

(75) Inventors: Sergey I. Bykov, Redmond, WA (US); Charles Joseph Williams, Redmond, WA (US); Raed M.N. Malhas, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/546,043

(22) Filed: Oct. 10, 2006

(51) Int. Cl. G06Q 40/00

(52) U.S. Cl. 705/40

(57) ABSTRACT

Described is a technology by which a payment abstraction layer enables application program developers to setup and/or enhance application programs to accept several payment tenders (e.g., including credit, debit, check and so forth) without requiring the application programs to implement the particular details of each payment solution provider. The payment abstraction layer provides enumeration methods and payment-related methods that are called by an application program to process payment-related input data, and instantiates payment objects to communicate with payment service providers. The payment abstraction layer may further include a hierarchy of tender (payment instrument) classes in which one class encapsulates data for different types of tenders. Some payment-related methods may be independent of any tender type, whereby an application program only need call an appropriate method with tender input data regardless of its source.

### BACKGROUND

When merchants sell goods and services by accepting a payment instrument other than cash, e.g., a check, credit card, debit card, gift card so forth, the merchant deals with a payment service provider to collect payment. To this end, many merchants have a payment-enabled application program, such as a point-of-sale application program running on a terminal or set of terminals, that interfaces with the servers of the payment service providers.

One of the problems in the payment industry is that it is difficult to add support for multiple payment instruments to a payment-enabled application. This is primarily because processing each type of payment instrument usually requires a unique protocol and message format for sending payment data to a payment processor. For example, most payment processors have different protocols for authorizing a credit card transaction versus authorizing a debit card transaction versus authorizing a check transaction.

As a result, there are significant complexities associated with integrating a new or different payment service provider, (e.g., a credit card payment processor, debit payment processor, gift card service provider, or the like) with a payment-enabled application. These complexities result in high integration costs, which prevent most payment-enabled applications from supporting a wide number of payment service providers.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a payment abstraction layer provides payment-related methods that are called by an application program to process payment-related input data. The payment abstraction layer interfaces with payment service providers, including by instantiating a payment object that sends payment data to a selected payment service provider's payment processor in a protocol and message format required by that payment service provider payment processor. For example, the payment abstraction layer may provide a method for instantiating a payment object corresponding to the selected payment service provider. The payment abstraction layer may include an enumeration-related interface by which the application program locates a payment service provided by a service provider. One example payment abstraction layer provides payment-related methods including at least one enumeration-related method that provides a mechanism for the application program to discover each payment service configured on the system, and at least one object creation method that provides a mechanism for the application program to instantiate a payment object corresponding to a selected payment service.

The payment abstraction layer may further include a hierarchy of tender (payment instrument) classes in which one class encapsulates data for different types of tenders. For example, there may be a tender class that is hierarchically above a payment card class and a check-related class. In turn, a direct debit class and a check class may be hierarchically below the check-related class.

At least some payment-related methods may be independent of any tender type, whereby an application program only need call an appropriate method with input data. Examples of payment-related methods includes an authorize method, a charge method, a credit method, a refund method, a settle method, or a void method, or any combination thereof.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative, generalized example of an architecture that abstracts payment receiving devices and programs running thereon from payment processors of payment service providers.

FIG. 2 shows an example of a software stack running at a merchant computing device, including a payment abstraction layer that interfaces with the application program and payment processing platforms in a way that abstracts the application program from protocol and message requirements of the processing platforms of a payment service provider.

FIG. 3 shows example components of the payment abstraction layer and related components in an example implementation.

FIG. 4A comprises a representation of a tender class hierarchy in one example implementation.

FIG. 4B comprises a representation of extending the tender class hierarchy in one example implementation.

FIGS. 5A and 5B comprise a representation of a generic processing service object including at least some methods that are independent of any specific tender type.

FIG. 6 is a representation of how the payment abstraction layer architecture may be extended.

FIG. 7 is a representation of inputs (arguments) of an example Authorize operation (method call).

### DETAILED DESCRIPTION

Various aspects of the technology described herein are generally directed towards a payment abstraction layer that (among other benefits) enables software developers to set up and/or enhance application programs to accept several payment tenders (where “tender” generally refers to any type of value that is being exchanged, including credit card, debit card, check, coupons, loyalty, and so forth) without requiring the application programs to implement the particular details of each payment solution provider. With such a payment abstraction layer and architecture, each payment service provider may provide the functionality needed to properly complete a payment transaction with their service. Integration with each payment provider needs to be done only once, and is performed by the service provider. As a result, the payment abstraction layer architecture eliminates the integration costs, and facilitates straightforward and seamless integration between different application programs and different payment processors.

In one example implementation represented herein, the payment abstraction layer comprises a client-side .NET class library in a Windows®-based operating system environment, which allows application programs (e.g., written by independent software vendors) to abstract the information needed for a particular payment service provider. However, it can be readily appreciated that such an abstraction layer can be implemented in other ways, in other environments, and/or with other operating systems. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and payment processing in general.

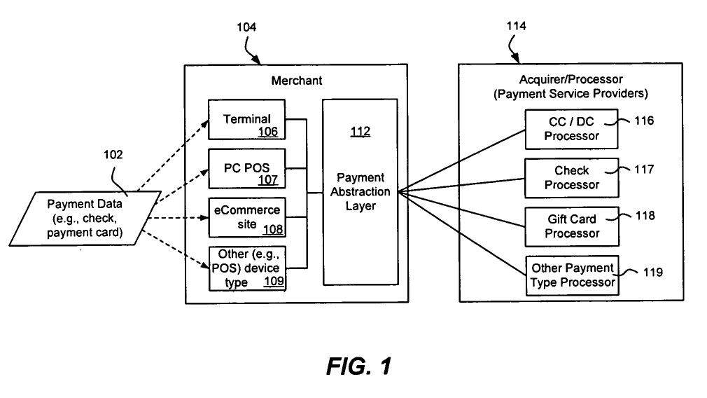

Turning to FIG. 1 of the drawings, there is shown a general concept of one example payment abstraction layer architecture, in which payment data 102 (e.g., an amount plus an account number from a payment card such as a magnetic stripe of a credit card, or the information regarding a check) is input to a payment receiving device of a merchant 104. The payment receiving device runs a payment-enabled application program. Example merchant payment receiving device s include a terminal 106, a personal computer point-of-sale (PC POS) 107, an eCommerce site 108, and any other (e.g., POS) device type 109, including future ones not yet developed. Note that in FIG. 1 that while the exemplified merchant 104 is shown as having various types of payment receiving devices 106-109, this is only for example purposes, and an actual merchant may have as little as one type of payment receiving device.

In general, regardless of the type of payment receiving device, the payment-enabled application program running thereon is able to interface with a payment abstraction layer 112 to communicate suitable payment-related information thereto. In turn, the payment abstraction layer 112 interfaces with an appropriate payment service provider (from among an available payment acquirer/processor set 114) for the type of payment being made. Example payment service providers represented in FIG. 1 include one or more that act as a credit card/debit card processor 116, a check processor 117, a gift card processor 118, and any other payment type processor 119, including for payment types not yet known or in use. Note that payment service providers are thus not limited to the traditional credit and debit service providers, but can include types such as online payment services, a coupon service provider, and future payment service types.

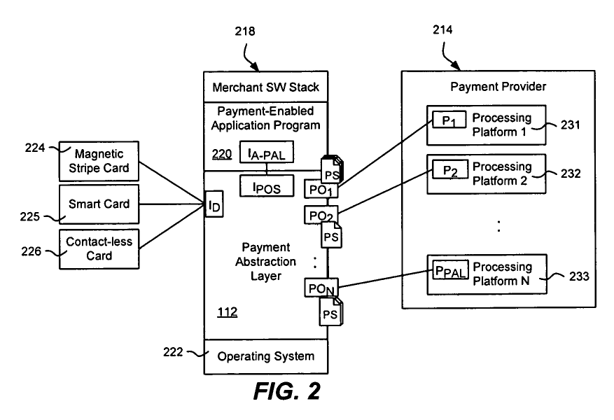

FIG. 2 is a representation of an example software stack 218 running on a merchant's payment receiving device, comprising a payment-enabled application program (e.g., point-of-sale software) 220, the payment abstraction layer 112 and an operating system 222. As represented in FIG. 2, the payment abstraction layer 112 functions to abstract payment instrument data and the payment processors' interfaces from local (e.g., point-of-sale) hardware and the application program 220.

The payment abstraction layer 112 standardizes tenders (that is, payment instruments) for the payment-enabled application program 220, regardless of the payment mechanism (the source) and the payment provider (the destination). Moreover, because in the example implementation the payment abstraction layer 112 runs above the operating system 222, any devices capable of running an operating system may act as payment terminals, including conventional personal computers, SmartPhones, Mobile PocketPCs, television set-top boxes and so forth.

As described herein, one way the interfacing may be accomplished is by writing the application program to call defined methods (e.g., a standardized API set) of the payment abstraction layer 112. To this end, in this example the payment-enabled application program 220 interfaces via an I_{A-PAL} interface with an I_{POS} interface of the payment abstraction layer 112. Note that the payment abstraction layer 112 also includes an interface I_{D} that allows the payment abstraction layer 112 to consume the input from any standard payment instrument, e.g., a magnetic stripe card 224, a smart card 225 and a contact-less card 226 are shown as examples. Alternatively, or in addition to, the payment-enabled application program 220 may accept the input.

As also represented in FIG. 2, the payment abstraction layer 112 provides a set of payment objects PO₁-PO_{N} for communication with payment processors' proprietary interfaces. Note that while three are shown, it can be readily appreciated that there may be any practical number of such payment objects.

In general, the payment objects comprise plug-in code modules or the like, e.g., created by the payment service providers. Via the payment objects, application programs that interface with the payment abstraction layer 112 effectively couple to one or more payment services (PS) provided by a particular payment service provider 214, which in turn couple to the processing platforms 231-234 of the service provider 214 to process payment transaction on their services.

As represented in the example of FIG. 2, each payment service (PS) comprises a configuration of a payment object for a particular merchant to connect to a particular service provided by a payment service provider. Note that each payment service is associated with a payment object installed on the merchant's system. In one example implementation, payment services can be considered as maintained in a configuration file, which allows for persistence of the payment service over time and over multiple applications if necessary. As also represented in FIG. 2, there may be more than one payment service that use the same payment object installed on the system. As described below, the payment abstraction layer includes enumeration-related methods, whereby the application program 220 can discover the payment services configured on the system by calling an API, e.g., one such method is PaymentExplorer.GetServices/GetDefaultService.

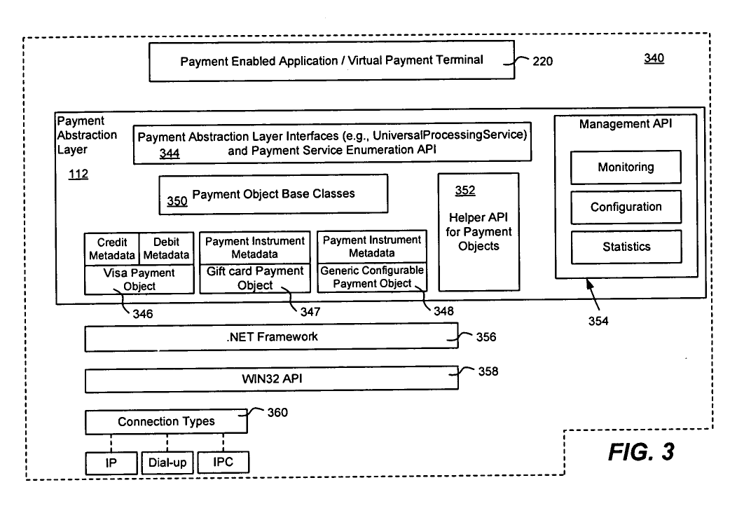

FIG. 3 shows a particular set of payment abstraction layer components and related components in one example architecture 340, namely in a Windows®/.NET environment. In general and as described above, the payment-enabled application 220 (e.g., running as a virtual payment terminal) comprises any application program that is used to process an electronic transaction in which a service provider is used to exchange value. Such payment-enabled application programs include traditional point of sale application programs or small business application programs like Microsoft Corporation's small business accounting products. Alternative types of payment-enabled application programs include any program that uses a backend service provider to exchange value, including web stores or mobile wallets, or payment-enabled embedded devices such as payment terminals or vending machines.

As also described above, the payment abstraction layer interfaces and payment service enumeration API 344 allows developers of payment-enabled applications to support any payment service provider, without having to program the details necessary for supporting particular payment service providers. This is facilitated via the payment objects (e.g., three are shown, labeled 346-348), each typically comprising a module created by a payment service provider, which provides the code necessary to properly format a payment message and appropriately route the message. Most of the payment processing work is thus done by the payment service provider's payment object, thereby providing the payment object developer with a high level of customization. This customization may take several forms, e.g., a payment object supporting multiple tender types, a payment object supporting multiple payment platforms from the same service provider, a payment object that uses a new or different type of encryption data flowing from the payment object to the service provider, and so forth.

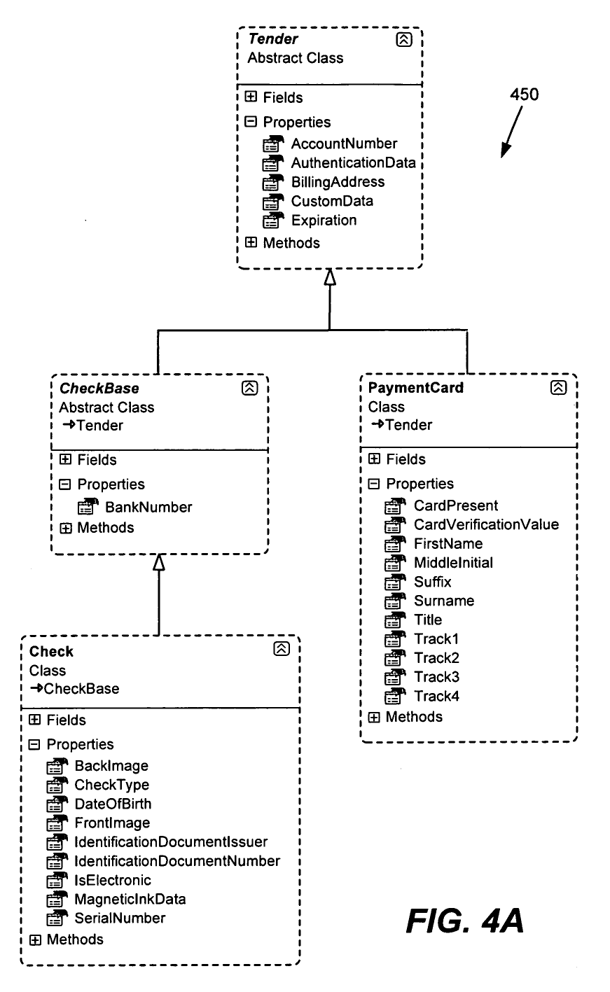

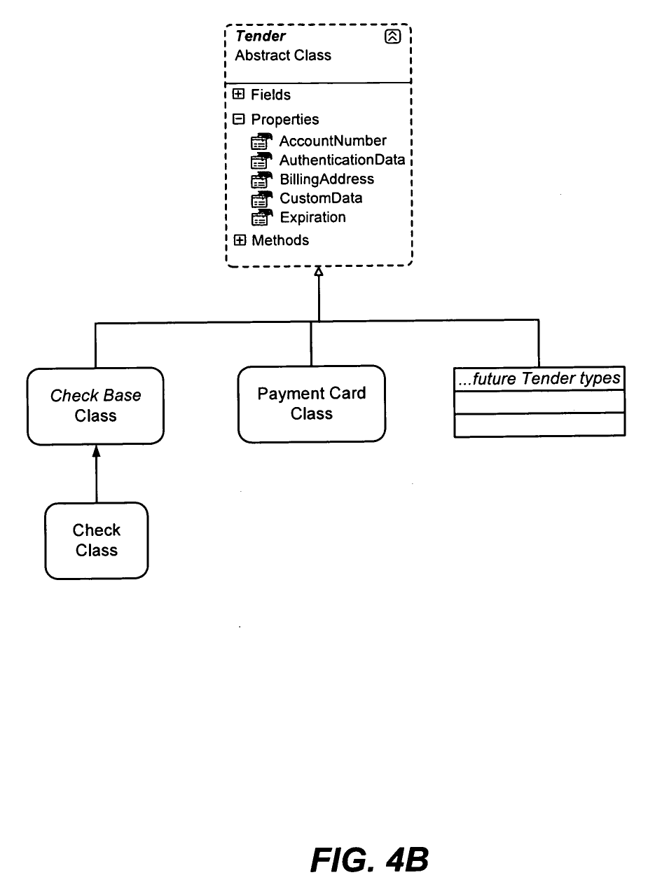

As generally represented in FIG. 4A, the payment abstraction layer 112 defines a generic tender hierarchy 450, but also allows for tender-specific functionality. For example, there may be a set of tender specific metadata (e.g., credit card, debit card, check) provided with the API. This tender hierarchy 450 allows adding additional tender types not specifically included in the payment abstraction layer.

The Tender class is a base class that acts as a container for tender data covering most of the tender types that exist today. There are several different payment tender classes derived from this class for the different payment types. As shown in FIG. 4A, in one example implementation, the payment tenders supported natively in payment abstraction layer include payment cards (such as credit cards, debit cards, gift cards, EBT cards, and so forth), and checks (paper and electronic checks).

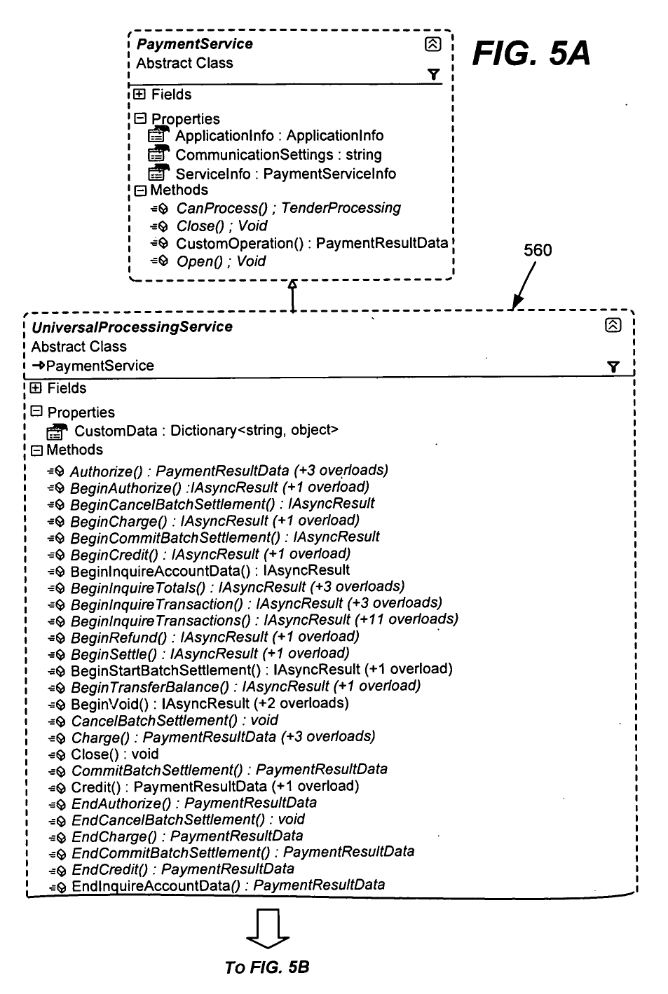

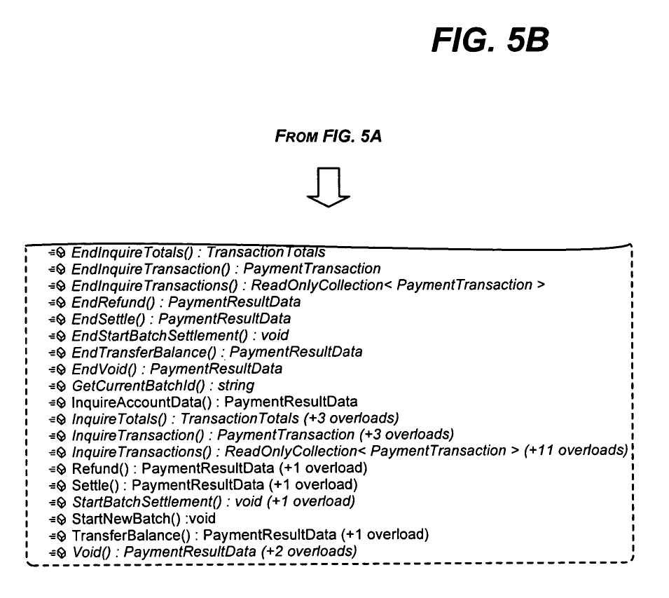

In general, most of the classes in the hierarchy 450 of generic payment instrument classes (i.e., tender classes) serve as containers to store the data needed to process multiple tenders (e.g., instead of just one) that have similarities in processing requirements. Classes in the tender hierarchy thus comprise generic containers for storing payment instrument data, such as magnetic stripe track data, magnetic ink character recognition data, and so forth, without necessarily knowing the actual payment instrument type. By way of example, a credit card, a debit card and a gift card can each have magnetic stripe track data. In case a card of any type is swiped through a magnetic stripe device, the application does not necessarily need to determine what kind of card it is. Instead, it puts the track data into an instance of PaymentCard and passes it as a parameter to a method of the processing object (e.g., a UniversalProcessingService object, described below with reference to FIGS. 5A and 5B). The processing object then determines the actual type of the card, and attempts to process the transaction. The application 220 only receives a result back that indicates whether or not the transaction has been approved. As can be seen, the details and requirements for processing that specific tender are masked from the application 220. Moreover, if the merchant decides to support a tender that has not been supported in the past, the payment abstraction layer 118 provides comprehensive handling of the different tenders through the architecture describe herein. The payment-enabled application 220 is thus able to accept the new tender without having to provide any application-specific implementations of the particular tender.

Note that the payment abstraction layer architecture is extensible to support new tender classes that may be introduced/adopted in the future. FIG. 4B also shows how the architecture can be extended to support other payment tenders that might be introduced in the future.

Returning to FIG. 3, there may be a payment object base class 350 that provides a base set of functionality from which service provider-specific payment object may inherit. The payment object base class 350 allows for quicker and more consistent implementation of base functionality for use by payment objects. Examples of base class functionality include having a SOAP-enabled payment object, having built-in performance counters, and so forth. Further, a helper API 352 may be provided to help payment objects interact with any non-core functionality, e.g., for secure storage, encryption/decryption, and so forth.

Management APIs 354 also may be provided to assist in the management of the payment objects (while not managing the payments themselves). Management may include providing various functionality such as configuration, monitoring and statistics. Configuration allows a payment object to obtain business-specific information, for example, merchant ID, terminal ID and/or to specify which processing platform a merchant is using.

Also shown in FIG. 3 below the NET framework 356 and Win32 APIs 358 are connection types 360, which are available to route the payment messages. Examples shown include IP, dial-up and Inter-Process Communication (IPC); however it is understood that there may be more or fewer connection types, depending on types supported in the operating system. In the TCP/IP case, the message may be routed either over the Internet to a payment service provider, or to a location inside a corporate network, e.g., to a payment server or the like. In the dial-up connection case, the existing payment network infrastructure may be used where the payment service provider is connected to directly, either by a dedicated ISDN line, or through the traditional telephony network. IPC may be used to route the payment message to a different process running on the machine.

As described above, a payment object comprises a code module that allows applications to connect to one or more payment services provided by a payment service provider. A payment service is a configuration of a payment object for a merchant to connect to a particular service provided by a payment service provider. Each payment service is associated with a payment object installed on the system. To use a payment object, the application needs to instantiate the payment object for the payment service in the context of the payment service and passing the object for the service it wants to use.

When a payment object is installed on a machine that is available to a payment application, the application can enumerate all the available payment services the payment object provides. The application can choose the appropriate payment service that provides the functionality needed by the merchant needs to process payments, then the application can create an instance of that payment object and process payments as needed.

To provide enumeration functionality in one example implementation, the payment service enumeration API 344 (e.g., corresponding to a PaymentExplorer class in the payment abstraction layer 112) provides a way for the payment-enabled application 220 to enumerate the payment services that are available, in order to create an instance of the appropriate payment object. The PaymentExplorer class includes functionality for enumeration of service providers; for example, via PaymentExplorer, the application 220 can enumerate available payment services in a number of ways. These include getting the payment service that matches the required payment service name, getting the default payment service that supports the specified tender type, getting all available payment services, and getting the payment services that conform to a particular criteria specified, e.g., tender type, compatibility and so forth.

Via enumeration, the application can create an instance of the payment object that refers to a particular payment service that the application wants to use. For enumeration in one example implementation, methods include GetDefaultService, which takes tender type and optionally tender subtype as parameters and returns the default service for that type/subtype. The methods returns a PaymentServiceInfo object that has metadata information about the default payment service. A GetServices method enumerates the available payment services for the payment-enabled application, returning a collection of PaymentServiceInfo objects for any payment services that conforms to the particular selection criteria, e.g., supported tender type, and compatibility. The GetService method returns a particular payment service for the specified name as a PaymentServiceInfo object that has metadata information about that particular payment service. Service names are unique, and if a service with such a name does not exist, GetService returns null.

With respect to instantiation, in one example implementation a CreateInstance method creates a payment object instance of the appropriate payment object installed that provides the functionality needed to process the payment service that the application wishes to use. The application 220 calls the CreateInstance method to create an instance of the payment object that provides the functionality needed for the payment service with which it wants to interact. The application passes the particular PaymentServiceInfo object as a parameter to CreateInstance method, and CreateInstance returns a PaymentService object that needs to be casted to the appropriate processing interface class, such as UniversalProcessingService (described below).

An example summary of how instantiation occurs follows, in which the application calls PaymentExplorer.CreateInstance(PaymentServiceInfo) to create an instance of the payment object associated with the service with which the application wants to interact. CreateInstance returns a PaymentService object that needs to be casted to the appropriate payment processor interface class. Most commonly, it will be casted to UniversalProcessingService interface.

More particularly, one or more universal payment processing interface classes may be provided, e.g., in the form of a UniversalProcessingService class 560 (FIGS. 5A and 5B) that provides the functionality needed to process payments for most of the existing tender types (e.g., payment cards, PIN payment cards, and checks). For example, the UniversalProcessingService class 560 represented in FIGS. 5A and 5B has methods such as Authorize, Charge, Credit, Refund, Settle, Void, StartBatchSettlement and so forth that take an instance of the base tender class, i.e. Tender, as one of the parameters of the call. This simplifies writing payment-enabled applications because such an application needs to be written against only one processing interface, UniversalProcessingService, regardless of the tender type.

In general, the UniversalProcessingService 560 provides a generic processing interface capable of processing multiple payment instrument types, which masks tender-specific processing requirements from the application. Depending on a given application's requirements, the application may need synchronous or asynchronous processing of payments. In one example implementation, the UniversalProcessingService interface 560 provides functionality to handle both synchronous and asynchronous processing of payments.

For example, when an application can process one payment transaction at a time and is able to wait for that payment transaction to finish before starting a new payment transaction, then the application uses the synchronous interface of the UniversalProcessingService. Some of the synchronous operations provided by UniversalProcessingService interface to process payments include Authorize, Charge, Credit, Refund, Settle, Void, and so forth.

When an application needs to process multiple payment transactions at a time and cannot wait for a particular payment transaction to finish before starting new payment transactions, then the application uses the asynchronous methods of the UniversalProcessingService interface 560. Some of the asynchronous operations provided by the UniversalProcessingService interface for such processing include BeginAuthorize, BeginCharge, BeginCredit, BeginRefund, BeginSettle, and so forth. For each of the asynchronous operations, the begin operation needs to be ended using an appropriate ‘End’ operation, e.g., EndAuthorize, EndCharge, EndCredit, EndRefund, EndSettle, and so forth.

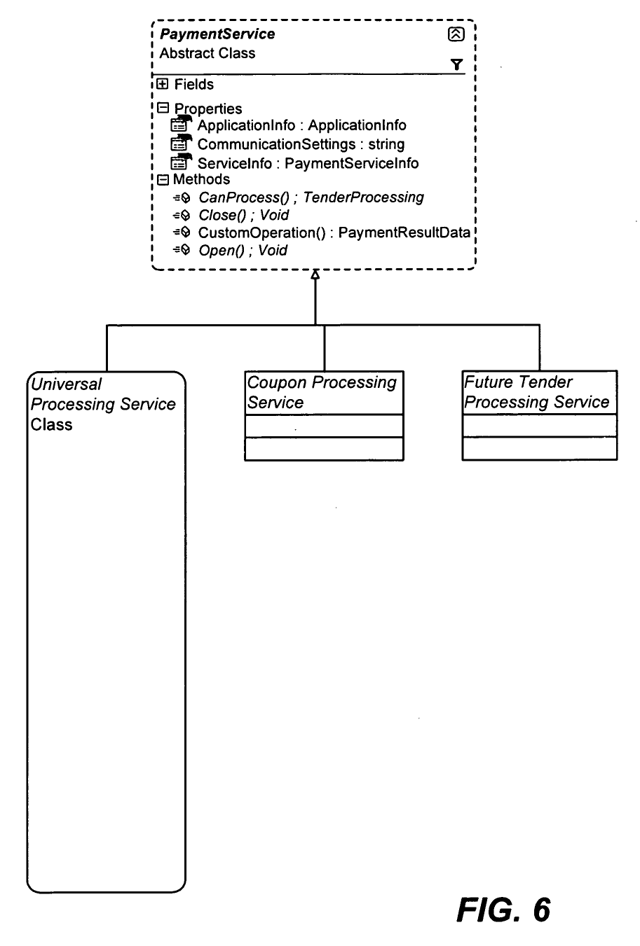

As generally represented in FIG. 6, the payment abstraction layer architecture is extensible so that it can be expanded to future tender types needing different processing functionality than that provided by the UniversalProcessingService interface. More particularly, by retuning a PaymentService object when a payment object is instantiated, the APIs provide for this extensibility. The PaymentService object can be casted to a newly defined interface that better processes this new tender type.

If a new payment type gets adopted by/introduced into the market that needs a different payment processing interface than that provided by the UniversalProcessingService class, the payment abstraction layer 112 can be easily extended to add another payment processing class to handle this new payment type. In this case, the PaymentService object that was returned by CreateInstance would be casted to this new class type, rather than UniversalProcessingService. Note that the UniversalProcessingService class itself can be extended later (e.g., add new properties/methods/events) to support more functionality.

By way of an example in FIG. 6, consider a new coupon processing service to be supported in the payment abstraction layer, in which the coupon processing service processes coupons differently from payment cards and checks. To support this, a new interface class that derives from PaymentService may be created. This interface class is used in place of UniversalProcessingService, but unlike UniversalProcessingService, it might define operations like RedeemCoupon, ValidateCoupon, and the like.

Note however that while the payment abstraction layer APIs are extensible, adding new interface classes is undesirable because payment applications would have to be re-written to support the new processing class. New classes should only be added if found that the new tender requiring support cannot be handled by the functionality already provided by the UniversalProcessingService interface.

Returning to FIGS. 5A and 5B, methods are provided by the UniversalProcessingService interface class 560 that can be used to process payments such as payment cards and checks. The application calls the appropriate method to perform the needed function to process a payment with the service provider. Some of the methods in UniversalProcessingService return a PaymentResultData object, which in one example returns an Approved result, a Declined result, a PartialApproval result, an ApprovedCheckID result, a CallIssuer result, a CallProcessor result, or an ImprintCard result.

As described herein, some of the operations provided by the UniversalProcessingService interface class include:

Authorize (Tender, PaymentData, ReferenceId, BasketData (optional))
Charge (Tender, PaymentData, ReferenceId, BasketData (optional))
Credit (Tender, PaymentData, ReferenceId, BasketData (optional))
Refund (Tender, PaymentData, ReferenceId,
TransactionAuthorizationData)
Settle (Tender, PaymentData, ReferenceId, TransactionAuthorizationData)
Void (Tender (optional), TransactionAuthorizationData)
StartBatchSettlment ( )
CommitBatchSettlement ( )
StartNewBatch ( )
CancelBatchSettlement ( )
GetCurrentBatchId ( )
CanProcess(Tender)
TransferBalance(Tender (from), Tender (to))
InquireAccountData(Tender, Currency)

The above operations correspond to methods of the UniversalProcessingService class. The tender processing methods such as Authorize, Charge, and the like take the parameters including PaymentData, a container object that details the payment amount; Tender, a container object that details the payment tender and BasketData, an optional container object that provides the details about each item in the consumer's basket such as Name, Price, Quantity, and TaxRate.

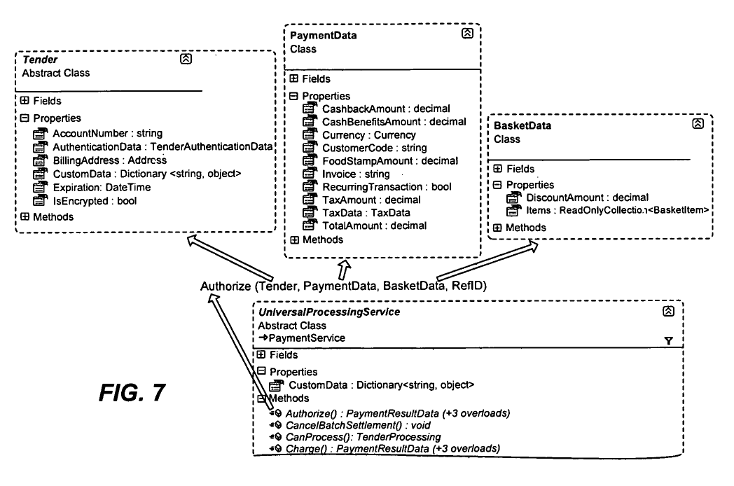

FIG. 7 shows such operation results in an “Authorize” method call example. Note that with respect to the PaymentData Class, the PaymentData object may include information about the payment amount, such as Amount, Currency, CashBack, and Tax. Further, note that there are several categories of business that are required to provide/save additional information to the payment data, e.g., categories such as Lodging (LodgingPaymentData) an Restaurant (RestaurantPaymentData).

### EXAMPLE APIS

The following section details the classes in one example Payment namespace.

### AccountData class comprises a container object that has information about the account data of the consumer.

Members

### Public Properties

| Property | Type | Description |
|---|---|---|
| AccountholderName | String | String showing the name of the consumer on |
| | | the account/tender being used for paying. For |
| | | example, this can be the name showing on the card |
| | | or check used for paying. |
| MaskedAccountNumber | String | String showing the masked account number. In |
| | | the case of a magnetic stripe card used for |
| | | paying, this will be the masked card number, etc. |
| AccountExpirationDate | String | String showing the expiration date on the |
| | | account/tender used for paying. For example, if |
| | | a magnetic stripe is used for paying, this would |
| | | be the expiration date of the card. |

### Address class comprises a container object that has information about the address of the consumer.

Members

### Public Properties

| Property | Type | Description |
|---|---|---|
| Name | String | String showing the name of the consumer |
| StreetAddress | String | String showing the Street address |
| City | String | String showing the city of the consumer |
| StateOrProvince | String | String showing the state or province of the |
| | | consumer |
| PostalCode | String | String showing the postal code |
| | | of the consumer |
| Country | String | String showing the country of the consumer |
| Phone | String | String showing the phone number of |
| | | the consumer |

### Constructors:

public Address(Address address)
public Address(string name, string streetaddress, string city, string stateOrProvince,
string postalCode, string country, string phone, string email)

Methods

### Clone Method

Creates a copy of the Address object.
public virtual Address Clone( )
AddressVerificationResult Enum comprises an Enum that shows the address verification result.

Values

| Values | Description |
|---|---|
| None | Returned when Address verification result is unknown |
| AddressAndNotPostalCode | Means address matches but postal code doesn't match |
| NeitherAddressNorPostalCode | Means both address and postal code don't match |
| AddressAndPostalCode | Means both address and postal code match |
| IneligibleTransaction | Means the transaction processed was ineligible. |
| VerificationNotSupportedByIssuer | Means the issuing bank doesn't provide address |
| | verification service. |
| AddressNotVerified | Means the address was not verified |
| PostalCodeAndNotAddress | Means the postal code matches but the address |
| | doesn't match |
| SystemUnavailable | Means the system is unavailable. |
| AddressInformationUnavailable | Means that there was no address information |
| | available to compare. |

### ApplicationInfo class comprises a class having information about the application.

Members

### Public Properties:

| Property | Type | Description |
|---|---|---|
| AssemblyName | Reflection.AssemblyName | Gets and sets the |
| | | application's assembly |
| | | name |
| FileVersion | String | Gets and sets the |
| | | file version |
| IsSigned | Boolean | Indicates whether the |
| | | application is signed or not |

AuthenticationResult Enum gets the result of payer authentication. For example, a customer can be asked to sign the receipt (when using a credit card) or enter a Pin (when using a debit card). The AuthenticationResult would reflect the result of authenticating the customer's signature or Pin in those cases.

Values

Failure
ServiceFailure
Success
Unknown
WrongData

### BasketData class comprises a container object that has information about each basket item for which the payment is being made.

Members

### Public Methods:

| | |
|---|---|
| AddItem | Adds an item to the basket |

### Public Properties

| Property | Type | Description |
|---|---|---|
| Items | Collections.ObjectModel.ReadOnlyCollection<BasketItem> | Returns a collection which is an object that has |
| | | details about each item in the basket such as: |
| | | Name, Price, Quantity, Code, and TaxRate |
| AdditionalDiscountAmount | Decimal | Gets and sets discount amount. This is the |
| | | discount applied by the Merchant to the total |
| | | basket (in addition to any existing individual |
| | | discounts applied to the different items in the |
| | | basket). |

### Constructors:

public BasketData ( );
public BasketData (BasketData basketData);
public BasketData (BasketData basketData, decimal discountAmount);

### Parameters:

1) basketData
Container object that has information about each basket item

2) discountAmount
Amount of discount

3) item
BasketItem object

Methods

### AddItem Method

Adds an item to the basket
public void AddItem (BasketItem item)

### Parameters

1) item
The item that is required to be added to the basket.

### BasketItem class comprises a container object that has information about each basket item for which the payment is being made.

Members

### Public Properties

| Property | Type | Description |
|---|---|---|
| Description | String | Shows the description of the item |
| | | (such as: carpet, sandwich, pop, shoes, |
| | | bananas, etc.) |
| ProductCode | String | Shows the Product code of the item |
| | | (can be a bar code, or just a designated |
| | | product code the Merchant |
| | | gives that item) |
| UnitPrice | Decimal | Shows the unit price of the item |
| Quantity | Decimal | Shows the quantity of the item (can be |
| | | number of items bought of any item, the |
| | | weight of it, measurement, etc.) |
| TaxRate | Decimal | Shows the tax rate of the item |
| TaxAmount | Decimal | Shows the tax amount of the item |
| Discount | Decimal | Shows the discount on the item |
| TotalAmount | Decimal | Shows the total amount price of the |
| | | item (which is calculated from the unit |
| | | price, tax amount, quantity, and |
| | | discount) |
| UnitOfMeasure | UnitOfMeasure | Shows the unit measure of the item |
| | | (which can be in Kilos, pounds, |
| | | centimeters, etc.) |

### Constructors:

public BasketItem(string description, string productCode, decimal unitPrice, decimal quantity, UnitOfMeasure unitOfMeasure, decimal discount, decimal taxRate, decimal taxAmount);
public BasketItem(string description, string productCode, decimal unitPrice, decimal quantity, decimal taxRate, decimal taxAmount)
public BasketItem(string description, string productCode, decimal unitPrice, decimal quantity)
public BasketItem(string description, string productCode, decimal unitPrice, decimal quantity, UnitOfMeasure unitOfMeasure)
public BasketItem(string description, decimal unitPrice, decimal quantity, decimal taxRate, decimal taxAmount)
public BasketItem(string description, decimal unitPrice, decimal quantity) public BasketItem(string description, decimal unitPrice, decimal quantity, UnitOfMeasure unitOfMeasure)

### Parameters:

1) description
the description of the item

2) productCode
showing product code

3) unitPrice
showing unit price

4) quantity
showing of an item

5) unitOfMeasure
Enum reflecting the appropriate unit of measure

6) discount
showing discount amount on item

7) taxRate
showing tax rate on item

8) taxAmount
showing tax amount for item

Methods

### Clone Method—creates a copy of the BasketItem object.

public virtual BasketItem Clone( )

### CardVerificationResult Enum comprises an Enum that has the different results of Cvv

Values

Failure
IssuerNotRegistered
NotProcessed
Success
Unknown

### CheckType Enum comprises an Enum that has the check types.

Members

### Public Properties:

Business
Personal
Unknown

Currency Struct—this class contains information about the currency. It is used as a parameter in the PaymentData class and InquireAccountData method to determine the currency to be used.

Members

### Public Properties

| Property | Type | Description |
|---|---|---|
| Code | CurrencyCode | Enum showing the currency code |
| Name | String | Showing the name of the currency |

### Static Properties

| Property | Type | Description |
|---|---|---|
| Eur | CurrencyCode | Enum showing the currency code for Euro |
| | | currency |
| Jpy | CurrencyCode | Enum showing the currency code for |
| | | Japenese currency |
| Usd | CurrencyCode | Enum showing the currency code for United |
| | | States currency |
| Aud | CurrencyCode | Enum showing the currency code for |
| | | Australian currency |
| Cad | CurrencyCode | Enum showing the currency code for |
| | | Canadian currency |
| Mxn | CurrencyCode | Enum showing the currency code for |
| | | Mexican currency |
| Gbp | CurrencyCode | Enum showing the currency code for the |
| | | United Kingdom currency |

### Eur, Jpy and Usd, etc. are static properties that return pre-initialized instances of Currency for programmers' convenience

### Constructors:

public Currency(CurrencyCode code);
public Currency(CurrencyCode code, string name)

### Parameters:

1) code
Enum showing the currency code

2) name
String showing name of the currency

### CurrencyCode Enum—an Enum that shows the currency codes.

NOTE: only a few of the currency code that are in the Enum are mentioned here since the list in the actual Enum is comprehensive to contain all the available currency codes. These codes were derived from: http://www.iso.org/iso/en/prods-services/popstds/currencycodeslist.html

Values

Aed
Afn
All
Amd
Ang
. . .

### PaymentData class—comprises a container object that has information about the payment amount.

Members

### Public Properties:

| Property | Type | Description |
|---|---|---|
| CashbackAmount | Decimal | Decimal: Gets and sets the cash back amount |
| Currency | Currency | Gets and sets the currency of the payment |
| CustomerCode | String | Gets and sets the customer code. |
| | | Customer code is required for processing |
| | | transactions for some types of |
| | | Purchase/Commercial cards. Purchase |
| | | Card offers businesses the ability to allow |
| | | their employees to purchase items with a |
| | | credit card while providing additional |
| | | information on sales tax, customer code, etc. |
| RecurringTransaction | Bool | Indicates whether or not the transaction is |
| | | recurring |
| TaxAmount | Decimal | Gets and sets the tax amount. |
| | | For example, a simple purchase might |
| | | just have a few basket items and a total |
| | | tax amount which is reflected in the |
| | | TaxAmount property. |
| | | In a different scenario, the basket might |
| | | have different items, some of which have |
| | | sales tax which is required to pass to the |
| | | processors. In this case, the application |
| | | uses TaxData to reflect tax details such |
| | | as sales tax, but combines the final total |
| | | tax amount in the TaxAmount property. |
| TaxData | TaxData | An object that shows information about the tax. |
| | | This property is optional to use by the |
| | | application. For example, for a purchase |
| | | that includes basket items that have sales |
| | | tax that is required to pass to the |
| | | processors. In this case, the application |
| | | uses TaxData to reflect tax details such |
| | | as sales tax, but combines the final total |
| | | tax amount in the TaxAmount property. |
| TotalAmount | Decimal | Shows the final total amount the payee |
| | | owes during a purchase. |
| | | For example, if a transaction includes |
| | | several items in a basket, the price of |
| | | these items will be added up, then if there |
| | | a TaxAmount it will be added as well to |
| | | that amount; which all-together sums the |
| | | TotalAmount in that case. |
| FoodStampAmount | Decimal | Shows the amount for food stamps as part of EBT |
| | | payments |
| CashBenefitsAmount | Decimal | Shows the amount for cash benefits as part of EBT |
| | | payments |
| Invoice | String | Gets and sets Invoice |

### Constructors

public PaymentData(decimal totalAmount)
public PaymentData(decimal totalAmount, decimal cashbackAmount)
public PaymentData(decimal totalAmount, decimal cashbackAmount, decimal foodStampAmount)
public PaymentData(decimal totalAmount, decimal cashbackAmount, decimal foodStampAmount, decimal cashBenefitsAmount)
public PaymentData(decimal totalAmount, decimal cashbackAmount, decimal foodStampAmount, decimal cashBenefitsAmount, decimal taxAmount)
public PaymentData(decimal totalAmount, decimal cashbackAmount, decimal foodStampAmount, decimal cashBenefitsAmount, TaxData taxData)
public PaymentData(decimal totalAmount, decimal cashbackAmount, decimal foodStampAmount, decimal cashBenefitsAmount, decimal taxAmount, Currency currency)
public PaymentData(decimal totalAmount, decimal cashbackAmount, decimal foodStampAmount, decimal cashBenefitsAmount, TaxData taxData, Currency currency)
public PaymentData(decimal totalAmount, decimal cashbackAmount, decimal foodStampAmount, decimal cashBenefitsAmount, decimal taxAmount, Currency currency,string customerCode)
public PaymentData(decimal totalAmount, decimal cashbackAmount, decimal foodStampAmount, decimal cashBenefitsAmount, TaxData taxData, Currency currency, string customerCode)
public PaymentData(decimal totalAmount, decimal cashbackAmount, decimal foodStampAmount, decimal cashBenefitsAmount, decimal taxAmount, Currency currency, string customerCode, bool recurringTransaction)
public PaymentData(decimal totalAmount, decimal cashbackAmount, decimal foodStampAmount, decimal cashBenefitsAmount, TaxData taxData, Currency currency, string customerCode, bool recurringTransaction)
public PaymentData(decimal totalAmount, decimal cashbackAmount, decimal foodStampAmount, decimal cashBenefitsAmount, decimal taxAmount, Currency currency, string customerCode, bool recurringTransaction, string invoice)
public PaymentData(decimal totalAmount, decimal cashbackAmount, decimal foodStampAmount, decimal cashBenefitsAmount, TaxData taxData, Currency currency, string customerCode, bool recurringTransaction, string invoice)
public PaymentData(PaymentData amount)

### Parameters:

1) totalAmount
shows the total amount

2) cashbackAmount
shows the cash back amount

3) taxAmount
shows the tax amount

4) taxData
object containing information about the tax data

5) customerCode
String showing customer code

6) currency
Object showing information about the currency

7) recurring
indicating whether or not a transaction is a recurring one

8) invoice
shows the invoice

Methods

### Clone Method

Creates a copy of the PaymentData object.
public virtual PaymentData Clone( )

### PaymentException Class

This class may be an abstract base class for PAL exceptions such as: PaymentObjectException and PaymentLibraryException.

### Constructors:

protected PaymentException( )
protected PaymentException(string message)
protected PaymentException(string message, System.Exception exception)
protected PaymentException(string message, int errorCode)
protected PaymentException(string message, int errorCode, System.Exception exception)
protected PaymentException(System.Runtime.Serialization.SerializationInfo serialization Info, System.Runtime.Serialization.StreamingContext streamingContext)

### Parameters:

1) message
A String showing the error message.

2) exception
The inner exception.

3) errorCode
An integer showing the error code.

4) serializationInfo
An object showing the serialization information.

5) streamingContext
An object showing the streaming context

### PaymentExplorer class—provides methods that are used to enumerate available payment services and instantiate payment objects associated with the different service providers.

Exceptions thrown:

### When a PaymentExplorer object is first instantiated (using CreateInstance method), the configuration files (global and user) will go through schema validation, if an error is found in one of the files, an exception will be thrown.

Additional error handling is done in GetDefaultService and GetService methods. If critical errors are found, then exceptions are thrown. This is detailed in the appropriate method sections.

Members

### Public Methods:

| | |
|---|---|
| CreateInstance | Creates an instance of the Payment Object |
| | for a specific Payment Service |
| GetDefaultService | Retrieves the default Payment Service based |
| | on the requested tender type |
| GetService | Retrieves the appropriate Payment Service based |
| | on the requested payment service name. |
| GetServices | Retrieves a collection of available Payment Services |
| | that support the requested tender type. |
| Refresh | Refreshes the list of Payment Services |

### Constructors

public PaymentExplorer ( );

Methods
CreateInstance Method creates an instance of the payment object for the given payment service.
public PaymentService CreateInstance(PaymentServiceInfo service);

### Parameters

1) service
PaymentServiceInfo object: returned by GetDefaultService, GetService, or GetServices

### Returns

A PaymentService object.

### Exceptions:

Throws a PaymentLibraryException if no appropriate provider was found that provides the payment service requested.
GetDefaultService Method—takes tender type and optionally tender subtype as parameters and returns the default service for that type/subtype.
public PaymentServiceInfo GetDefaultService(TenderType tenderType)
public PaymentServiceInfo GetDefaultService(TenderType tenderType, string tenderSubtype)

### Parameters:

1) tenderType
Enum that specifies the tender type (such as: credit card, debit card, check, etc.) the payment service needs to support.

2) tenderSubtype
String that specifies the tender type (such as: in the case of a tender of type “credit card”, the subtypes can be: Visa, Master Card, American Express, etc.) the payment service needs to support.

### Returns

PaymentServiceInfo object for the payment service or null if none was found.

### Exceptions:

Throws a PaymentLibraryException exception if there is more than one appropriate payment service available and none of them is set as default.
GetService Method—retrieves a Payment Service that matches the payment service name requested.
public PaymentServiceInfo GetService(string serviceName)

### Parameters:

1) serviceName
String that specifies the name of the payment service required

### Returns

PaymentServiceInfo object for the payment service or null if none was found.

### Exceptions:

Throws a PaymentLibraryException exception if there is more than one payment service available with the same name.
GetServices Method—retrieves the collection of payment services available that supports the given tender type and compatibility level, or a collection of available payment services.
public System Collections.ObjectModel.ReadOnlyCollection<PaymentServiceInfo>GetServices( )
public System.Collections.ObjectModel.ReadOnlyCollection<PaymentServiceInfo>GetServices(TenderType tenderType)
public System.Collections.ObjectModel.ReadOnlyCollection<PaymentServiceInfo>GetServices(TenderType tenderType, string tenderSubtype)
public System.Collections.ObjectModel.ReadOnlyCollection<PaymentServiceInfo>GetServices(TenderType tenderType, PaymentObjectCompatibilities compatibility)
public System.Collections.ObjectModel.ReadOnlyCollection<PaymentServiceInfo>GetServices(TenderType tenderType, string tenderSubtype, PaymentObjectCompatibilities compatibility)
public System.Collections.ObjectModel.ReadOnlyCollection<PaymentServiceInfo>GetServices(PaymentObjectCompatibilities compatibility)

### Parameters:

1) tenderType
Enum that specifies the tender type (such as: credit card, debit card, check, etc.) the payment service needs to support.

2) tenderSubtype
String that specifies the tender type (such as: in the case of a tender of type “credit card”, the subtypes can be: Visa, Master Card, American Express, etc.) the payment service needs to support.

3) compatibility
Payment compatibilities object that shows one of the following levels of interface capabilities: Desktop, Mobile and DesktopAndMobile

### Returns

ProviderCollection object which is a collection of PaymentServiceInfo objects.
   PaymentLibraryException class—PaymentLibraryException is thrown by the PAL library when it gets into an exceptional condition. This class is derived from PaymentException class.

### Constructors:

public PaymentLibraryException( )
public PaymentLibraryException(string message)
public PaymentLibraryException(string message, System.Exception exception)
protected PaymentLibraryException(System.Runtime.Serialization.SerializationInfo
serializationInfo, System.Runtime.Serialization.StreamingContext streamingContext)

### Parameters:

1) message
A String showing the error message.

2) exception

The inner exception.

3) serializationInfo
An object showing the serialization information.

4) streamingContext
An object showing the streaming context

### PaymentObjectCompatibilities Enum—an Enum showing the levels of interface compatibilities of a payment object.

Values

Value

Desktop
DesktopAndMobile
Mobile

### PaymentObjectException Class

### PaymentObjectException is thrown by the payment object when it gets into an exceptional condition.

### This class is derived from PaymentException class.

### Constructors:

public PaymentObjectException(string message)
public PaymentObjectException(string message, int errorCode)
public PaymentObjectException(string message, int errorCode, System.Exception exception)
protected PaymentObjectException(System.Runtime.Serialization.SerializationInfo serialization Info, System.Runtime.Serialization.StreamingContext streamingcontext) public PaymentObjectException( )
public PaymentObjectException(string message, System.Exception exception)

### Parameters:

1) message
A String showing the message of the exception.

2) exception
The exception thrown by the system.

3) errorCode
An integer showing the error code.

4) serialization Info
An object showing the serialization information.

5) streamingContext
An object showing the streaming context

Methods

### ToString Method

Returns the payment object exception.
public override string ToString( )

### PaymentResult Enum—an Enum that has the payment results.

Values

| Value | Description |
|---|---|
| Declined | The transaction request was declined by the processor. |
| PartialApproval | This result indicates that the service provider approved only a |
| | portion of the requested amount. For example, the balance of |
| | the stored value/debit card was lower than the requested |
| | amount and the rest needs to be paid by some other tender. |
| | Another example where this can happen is during batch |
| | settlement. When submitting a batch for settlement, some |
| | service providers submit settlement requests one at a time for |
| | each item in a batch. As a result, if one or more settlement |
| | requests fail, a bunch of other requests may already be |
| | approved. So the PO will return PartialApproval in this case. |
| Approved | This is received when the transaction is approved. |
| ApprovedCheckID | This result indicates that the transaction is approved but the |
| | Merchant should check the customer's Id. |
| CallIssuer | This result indicates that the Merchant should call the issuing bank |
| CallProcessor | This result indicates that the Merchant should call the processor |
| ImprintCard | This result indicates that the Merchant should imprint the card |

PaymentResultData class—an object instance of PaymentResultData is returned by some of the payment operation methods of the UniversalProcessingService class. PaymentResultData has information about the result of a payment processing operation.

Members

### Public Properties:

| Property | Type | Description |
|---|---|---|
| AddressVerificationResult | AddressVerificationResult | gets the result of verifying the |
| | | address of a customer. |
| AuthenticationResult | Authentication | gets the result of the authenticating |
| | Result | the payer. For example, a customer |
| | | can be asked to sign the slit of a |
| | | payment (when using a credit card) |
| | | or enter a Pin (when using a debit |
| | | card). The AuthenticationResult |
| | | would reflect the result of |
| | | authenticating the customer's |
| | | signature or Pin in those cases |
| AuthorizationData | TransactionAuthorizationData | Gets the result of the authorization |
| | | such as: transaction Id, approved |
| | | amount, available balance, etc. |
| CardVerificationResult | CardVerificationResult | Gets the result of the card |
| | | verification code/value (which can |
| | | be 3 or 4 digit value that reside at |
| | | the back of the card). |
| InnerResults | System.Collections.ObjectModel.ReadOnlyCollection<PaymentResultData> | Gets the individual results of nested |
| | | PaymentResultData, for example, |
| | | for results of individual settle |
| | | requests submitted in a batch. |
| ReferenceId | String | Gets the reference Id which is |
| | | generated by the application. |
| Result | PaymentResult | Enum: Result of the operation: |
| | | Approved, Declined, |
| | | PartialApproval, ApprovedCheckID |
| | | CallIssuer, CallProcessor, |
| | | ImprintCard. |
| ResultCode | Int | Int: numeric result code |
| ResultMessage | String | String: message with description of |
| | | the result |
| SettlementTenderData | SettlementTenderFields | Gets the tender data required to |
| | | complete a settlement transaction |
| TransactionDateTime | DateTime | DateTime of the transaction |
| Exception | System.Exception | Shows any exception returned. |
| | | This property would be used in |
| | | cases such as: to handle batch |
| | | settlement. So, if one item in the |
| | | batch fails to settle (and returns an |
| | | exception), the PO might decided to |
| | | consume that exception instead of |
| | | throwing it and return |
| | | PartialSuccess so the whole batch |
| | | doesn't fail. |
| IsSignatureRequired | Boolean | The value of this property indicates |
| | | whether or not a customer's |
| | | signature is required to process a |
| | | payment. |
| | | It would tell the application whether |
| | | or not to print signature line on the |
| | | receipt. This gives the service |
| | | provider the flexibility to decide for |
| | | what transaction, what tender |
| | | types/subtypes and amounts |
| | | signature is required. |

### Constructors:

public PaymentResultData(PaymentResult result)
public PaymentResultData(PaymentResult result, string referenceId)
public PaymentResultData(PaymentResult result, int resultCode, string referenceId)
public PaymentResultData(PaymentResult result, int resultCode, string resultMessage, string referenceId)
public PaymentResultData(PaymentResult result, int resultCode, string resultMessage, TransactionAuthorization Data authorization Data, System.DateTime transactionDateTime, string referenceId)
public PaymentResultData(PaymentResult result, int resultCode, string resultMessage, TransactionAuthorization Data authorization Data, System.DateTime transaction DateTime, SettlementTenderFields settlementTenderData, string referenceId)
public PaymentResultData(PaymentResult result, int resultCode, string resultMessage, TransactionAuthorization Data authorizationData, System.DateTime transactionDateTime, AddressVerificationResult addressVerificationResult, Authentication Result authenticationResult, string referenceId)
public PaymentResultData(PaymentResult result, int resultCode, string resultMessage, TransactionAuthorization Data authorizationData, System.DateTime transactionDateTime, AddressVerification Result addressVerification Result, Authentication Result authentication Result,.CardVerificationResult cardVerificationResult, string referenceId)

Methods
AddInnerResult Method—Adds an inner result of a nested PaymentResultData (that might be used for results of individual settle requests submitted in a batch).
public void AddInnerResult(PaymentResultData result)
   PaymentService class—an instance of an object of this class gets returned when PaymentExplorer.CreateInstance method is called. It acts as a place holder that gets casted to the appropriate payment service provider interface class (such as UniversalProcessingService interfaces).

Members

### Public Properties

| Property | Type | Description |
|---|---|---|
| ServiceInfo | PaymentServiceInfo | Gets the ServiceInfo object |
| CommunicationSettings | String | Gets a string indicating the service |
| | (protected | provider's communication settings such |
| | property) | as URL, phone number to dial, etc. |
| ApplicationInfo | ApplicationInfo | Object containing the application info |
| | (protected | |
| | property) | |

### Public Methods

| | |
|---|---|
| Open | Opens the communication with the appropriate |
| | payment processing interface class |
| Close | Closes the communication with the appropriate |
| | payment processing interface class |
| CustomOperation | This is a custom operation that takes operationCode |
| | as a parameter as well as a data object. It returns |
| | PaymentResultData that has the result of the operation. |
| CanProcess | Figures out whether or not the payment service can |
| | process a tender |

### Protected Methods

| | |
|---|---|
| GetConfigurationProperty | Lets payment object read values of its |
| | configuration properties. |

Methods
CustomOperation Method—Invokes a service provider specific operation. Should not be used unless necessary as any such functionality will be incompatible between processors.
public virtual PaymentResultData CustomOperation(int operationCode, object data)
GetConfigurationProperty Method—lets payment object read values of its configuration properties. This is a protected method.
protected string GetConfiguration Property(string propertyName)
CanProcess Method—figures out whether the payment service can process a tender or not
public abstract TenderProcessing CanProcess(Tender tender)

### Parameters:

1) tender
The tender object

### Returns

TenderProcessing object with the result of the operation.
Open Method—Opens the communication with the appropriate payment processing interface class.
public abstract void Open( )

### Parameters:

None
Returns

None
Close Method—Closes the communication with the appropriate payment processing interface class.
public abstract void Close( )

### Parameters:

None

### Returns

None

### PaymentServiceInfo class—provides metadata information about a specific service provider.

Members

### Public Properties:

| Property | Type | Description |
|---|---|---|
| CommunicationSettings | String | Gets a string indicating the |
| | | service provider's |
| | | communication settings such as |
| | | URL, phone number to dial, etc. |
| Compatibility | PaymentObjectCompatibilities | Gets payment compatibilities |
| | | object that shows one of the |
| | | following levels of interface |
| | | capabilities: Desktop, Mobile |
| | | and DesktopAndMobile |
| Description | String | Gets a string indicating the |
| | | payment object's description |
| Name | String | Gets a string indicating the |
| | | name of the service |
| ServiceProviderName | String | Gets a string indicating a the |
| | | name of the service provider |
| PaymentObjectName | String | Gets a string indicating the |
| | | payment object's name |
| PaymentObjectVersion | Version | Gets the payment object version |
| TenderTypes | System.Collections. | Gets the tender types supported |
| | ObjectModel.Read | by the service provider |
| | OnlyCollection<Tender | |
| | Type> | |

Methods
TenderSubtypes Method—this method returns a list of tender subtypes supported by a payment service for the given tender type.
public abstract System.Collections.ObjectModel.ReadOnlyCollection<string>TenderSubtypes(TenderType tenderType)
ToString Method—returns the payment service name.
public override string ToString( )
IsDefaultService Method—this method tells whether or not the service is configured to be default for the given tender type/subtype.
public abstract bool IsDefaultService(TenderType tenderType, string tenderSubtype)
   PaymentTransaction class—provides information about a previously committed transaction to the application. This information will come from the processor's back-end and will be delivered to the application by the payment object.

Members

### Public Properties:

| Property | Type | Description |
|---|---|---|
| Type | PaymentTransaction | Gets the type of transaction (whether |
| | Type | it was: Authorize, Charge, Refund, |
| | | etc.) |
| Status | PaymentTransaction | Gets the status of the transaction |
| | Status | (whether it was: Approved, Declined, |
| | | Settled, etc.) |
| Result | PaymentResultData | Gets the details of the result of the |
| | | transaction |
| Tender | Tender | Gets the type of tender used in the |
| | | transaction |
| PaymentData | PaymentData | Gets the details about the payment |
| | | amount for that transaction (such as: |
| | | total amount, tax, currency, etc.) |
| Id | String | Gets the transaction Id |

### Constructors:

public PaymentTransaction(PaymentTransactionType type, PaymentTransactionStatus
status, PaymentResultData result, string id, PaymentData paymentData)
public PaymentTransaction(PaymentTransactionType type, PaymentTransactionStatus
status, PaymentResultData result, string id, PaymentData paymentData, Tender tender)

### PaymentTransactionStatus Enum—Shows the payment transaction status.

Values

Approved
Declined
Settled
Void
Pending
Failed
Other

### PaymentTransactionType Enum—Shows the payment transaction type.

Values

Authorize
Charge
Settle
Refund
Credit
Void
Other

### PinData class—contains Pin data for a payee's card (such as debit card, etc.).

Members

### Public Properties:

| Property | Type | Description |
|---|---|---|
| EncryptionKeyData | String | Encryption key or other data |
| | | associated with the key that was |
| | | used for encrypting the PIN |
| EncryptionKeySerialNumber | Int | Gets and sets serial number of |
| | | the encryption key |
| EncryptedPin | String | Gets the Encrypted Key |

SettlementTenderFields Enum—shows the tender fields required to do a settlement transaction. SettlementTenderFields is returned in PaymentResultData when an “Authorize” transaction is called.

Values

AccountNumber
AccountholderName
AccountExpirationDate
None
PinData
TrackData

### TaxData Class

Contains the tax data information needed to complete a transaction.

Members

### Public Properties:

| Property | Type | Description |
|---|---|---|
| SalesTaxAmount | Decimal | Gets and sets Tax amount |
| SalesTaxRate | Decimal | Gets and sets tax rate |
| VatAmount | Decimal | Gets and sets vat amount |
| VatRate | Decimal | Gets and sets vat rate |
| CustomerTaxId | String | Gets and sets customer tax id |
| OtherTaxAmount | Decimal | Gets and sets tax amount |

### Constructors:

public TaxData(decimal salesTaxAmount, decimal salesTaxRate)
public TaxData(decimal salesTaxAmount, decimal salesTaxRate, decimal vatAmount,
decimal vatRate)
public TaxData(decimal salesTaxAmount, decimal salesTaxRate, decimal vatAmount,
decimal vatRate, decimal otherTaxAmount)
public TaxData(decimal salesTaxAmount, decimal salesTaxRate, decimal vatAmount,
decimal vatRate, string customerTaxId)
public TaxData(decimal salesTaxAmount, decimal salesTaxRate, decimal vatAmount, decimal vatRate, string customerTaxId, decimal otherTaxAmount)
public TaxData(decimal salesTaxAmount, decimal salesTaxRate, decimal vatAmount, decimal vatRate, string customerTaxId)
public TaxData(decimal salesTaxAmount, decimal salesTaxRate, decimal vatAmount, decimal vatRate, string customerTaxId, decimal otherTaxAmount)
public TaxData(TaxData taxData)

Members

### Clone Method

Creates a copy of the TaxData object.
public virtual TaxData Clone( )

### Tender Class

An (e.g., abstract) base class that is associated with an account number. There are several payment tender classes derived from this class for the particular tender types.

Members

### Public Properties:

| Property | Type | Description |
|---|---|---|
| AccountNumber | String | Account number associated with the |
| | | tender such as credit card number, |
| | | checking account number, etc. |
| AuthenticationData | TenderAuthenticationData | Authentication data such as Verified By |
| | | Visa, biometric information, etc. |
| BillingAddress | Address | Billing address of the payee |
| CustomData | Collections.Generic. | Additional data |
| | Dictionary<string, | |
| | object> | |
| Expiration | DateTime | Expiration date of the tender |

### Constructors:

protected Tender(string accountNumber)
protected Tender(string accountNumber, System.DateTime expiration)
protected Tender(string accountNumber, Address billingAddress)
protected Tender( )
protected Tender(Tender tender)
protected Tender(string accountNumber, DateTime expiration, Address billingAddress)
protected Tender(TenderAuthenticationData authenticationData)
protected Tender(string accountNumber, TenderAuthentication Data authentication Data)
protected Tender(string accountNumber, DateTime expiration,
TenderAuthentication Data authentication Data)
protected Tender(string accountNumber, DateTime expiration, Address billingAddress,
TenderAuthenticationData authentication Data)

Methods

### Clone Method—creates a copy of the Tender object.

public abstract Tender Clone( )

Classes Derived from Tender class
PaymentCard class—a container for data from a magnetic card such as credit/debit card, gift card, etc. This class is derived from Tender class.

### Members

Public Properties:

### NOTE: properties in italics are inherited properties.

| Property | Type | Description |
|---|---|---|
| CardNotPresent | Bool | Shows whether the card is |
| | | physically present at the time of |
| | | the transaction |
| CardVerificationValue | String | Card verification value |
| FirstName | String | Shows the first name |
| MiddleInitials | String | Shows the Middle Initial |
| Suffix | String | Shows the suffix |
| Surname | String | Shows the surname |
| Title | String | Shows the title |
| Track1 | Byte[ ] | Raw data from track 1 of the card |
| Track2 | Byte[ ] | Raw data from track 2 of the card |
| Track3 | Byte[ ] | Raw data from track 3 of the card |
| Track4 | Byte[ ] | Raw data from track 4 of the card |
| AccountNumber | String | Account number associated with |
| | | the tender such as credit card |
| | | number, checking account |
| | | number, etc. |
| AuthenticationData | TenderAuthenticationData | Authentication data such as |
| | | Verified By Visa, biometric |
| | | information, etc. |
| BillingAddress | Address | Billing address of the payee |
| CustomData | Collections.Generic.Dictionary | Additional data |
| | <string,object> | |
| Expiration | DateTime | Expiration date of the tender |

### Constructors:

public PaymentCard(PaymentCard card)
public PaymentCard(byte[] track1, byte[] track2)

public PaymentCard(byte[] track1, byte[] track2, TenderAuthenticationData authentication Data)
public PaymentCard(byte[] track1, byte[] track2, byte[] track3, TenderAuthenticationData authentication Data)
public PaymentCard(byte[] track1, byte[] track2, byte[] track3, byte[] track4) public PaymentCard(byte[] track1, byte[] track2, byte[] track3, byte[] track4, TenderAuthenticationData authenticationData)
public PaymentCard(string accountNumber)
public PaymentCard(string accountNumber, DateTime expiration)
public PaymentCard(string accountNumber, DateTime expiration, string firstName, string middleInitial, string surname, string title, string suffix)
public PaymentCard(string accountNumber, DateTime expiration, string firstName, string middlelnitial, string surname, Address billingAddress)
public PaymentCard( string accountNumber, DateTime expiration, string firstName, string middlelnitial, string surname, string cardVerificationValue)
public PaymentCard( string accountNumber, DateTime expiration, string firstName, string middlelnitial, string surname, Address billingAddress, string cardVerificationValue)

### Methods

Clone Method
Creates a copy of the PaymentCard object.
public override Tender Clone( )

ParselsoTrackData Method
Parses the ISO track data from a card
public virtual void ParselsoTrackData( )

### CheckBase Class

This may be an abstract base class that inheriting classes (such as Check class) can use to pass Check related data during payments transactions. This class is derived from Tender class.

### Members

### Public Properties:

### NOTE: properties in italics are inherited properties.

| Property | Type | Description |
|---|---|---|
| BankNumber | String | Gets and sets the bank number |
| AccountNumber | String | Account number associated with the |
| | | tender such as credit card number, |
| | | checking account number, etc. |
| AuthenticationData | TenderAuthentication | Authentication data such as Verified By |
| | Data | Visa, biometric information, etc. |
| BillingAddress | Address | Billing address of the payee |
| CustomData | Collections.Generic. | Additional data |
| | Dictionary<string,object> | |
| Expiration | DateTime | Expiration date of the tender |

### Constructors:

protected CheckBase(string bankNumber, string accountNumber)
protected Checkbase(string bankNumber, string accountNumber, string accountholderName)
   protected Checkbase(string bankNumber, string accountNumber, string accountholderName, Address billingAddress)
protected CheckBase(CheckBase check)

### Check Class

This class is used to send Check related data during payment transactions (such as: paper checks, electronic checks, etc.). This class is derived from CheckBase class.

Members

### Public Properties:

### NOTE: properties in italics are inherited properties.

| Property | Type | Description |
|---|---|---|
| BackImage | Drawing.Bitmap | has the image of the back of the check |
| FrontImage | Drawing.Bitmap | has the image of the front of the check |
| CheckType | CheckType | Object that gets/sets check type: |
| | | Business, Personal, or Unknown |
| DateOfBirth | DateTime | Gets and sets the date of birth |
| MagneticInkData | String | Gets and sets the magnetic ink data |
| IdentificationDocument | String | Gets and sets the Identification |
| Number | | document's number |
| IdentificationDocument | String | Shows the identification document's |
| Issuer | | issuer |
| IsElectronic | bool | Indicates whether a check is an |
| | | Electronic Check (ECheck) or not |
| SerialNumber | int | Shows the serial number of the check |
| BankNumber | String | Gets and sets the bank number |
| AccountNumber | String | Account number associated with the |
| | | tender such as credit card number, |
| | | checking account number, etc. |
| AuthenticationData | TenderAuthentication | Authentication data such as Verified By |
| | Data | Visa, biometric information, etc. |
| BillingAddress | Address | Billing address of the payee |
| CustomData | Collections.Generic. | Additional data |
| | Dictionary<string, | |
| | object> | |
| Expiration | DateTime | Expiration date of the tender |

### Constructors:

public Check( CheckType checkType, string bankNumber, string accountNumber, int serialNumber)
public Check(CheckType checkType, string bankNumber, string accountNumber, int serialNumber, bool isElectronic)
public Check( CheckType checkType, string bankNumber, string accountNumber, int serialNumber, string accountholderName, string identificationDocument, string identificationIssuer)
public Check( CheckType checkType, string bankNumber, string accountNumber, int serialNumber, string accountholderName, string identificationDocument, string identificationIssue, DateTime dateOfBirth )
public Check( CheckType checkType, string bankNumber, string accountNumber, int serialNumber, string accountholderName, string identificationDocument, string identificationIssuer, Address billingAddress)
public Check( CheckType checkType, string bankNumber, string accountNumber, int serialNumber, string accountholderName, string identificationDocument, string identificationIssuer, DateTime dateOfBirth, Address billingAddress)
public Check(string magneticInkData)
public Check(string magneticInkData, Bitmap frontImage)
public Check(string magneticInkData, Bitmap frontImage, Bitmap backImage)
public Check(Check check)
public Check( )

Methods

### Clone Method—creates a copy of the Check object.

public override Tender Clone( )

### TenderAuthenticationData Class

### This class contains the tender authentication data.

Members

### Public Properties:

| Property | Type | Description |
|---|---|---|
| Authentication | TenderAuthenticationTypes: | Gets the |
| Type | an Enum | authentication type |
| BinaryData | IO.BinaryReader | Gets the |
| | | BinaryReader object |
| Data | String | Gets the data |
| Image | Drawing.Bitmap | Gets the image |
| Signature | Collections.ObjectModel.Read | Gets the signature |
| | OnlyCollection<Point> | |
| PinData | PinData object | Gets the Pin data |

### Constructors

public TenderAuthenticationData(TenderAuthenticationTypes authenticationType, byte[] binaryData)
public TenderAuthenticationData(TenderAuthenticationTypes authenticationType, IO.BinaryReader binaryData)
public TenderAuthenticationData(TenderAuthenticationTypes authenticationType, Drawing.Bitmap image) public TenderAuthenticationData(TenderAuthenticationTypes authenticationType, string data)
public TenderAuthenticationData(Drawing.Point[] signature)
public TenderAuthenticationData(Collections.ObjectModel.ReadOnlyCollection<Point>signature)
public TenderAuthenticationData(TenderAuthenticationData data)
public TenderAuthenticationData(PinData pinData)
public TenderAuthenticationData(TenderAuthenticationTypes authenticationType)

### Parameters

1) authenticationType
TenderAuthenticationTypes Enum: returns the tender authentication type

2) binaryData
byte[] that shows the binary data

3) image
The image

4) signature
A drawing or a ReadOnlyCollection object that contains the signature

Methods

### Clone Method

Creates a copy of the TenderAuthenticationData object.
public virtual TenderAuthenticationData Clone( )

### TenderAuthenticationTypes Enum—an Enum that shows the tender authentication type.

Note: this Enum supports mixed values of the values below. An example of this is a Merchant who needs to send both biometric and signature data in a transaction.

Values

Other
None
Signature
VerifiedByVisa
MasterCardSecureCode
Biometric
PINData

TenderProcessing Enum—an Enum that shows the whether a specific tender can be processed by a service provider. TenderProcessing is returned when the CanProcess method is called.

Values

Supported
Unknown
Unsupported

TenderSubtype class—this is a static class that defines constants for the most popular tender subtypes. For example, in the case of the tender type: “Credit Card”, subtypes would be one of the following: “Visa”, “MasterCard”, “AmericanExpress”, etc.
TenderSubtype.CreditCard class—this is a static class that defines constants for the most popular credit card subtypes:

Constants

Visa
MasterCard
AmericanExpress
Discover
JCB
DinersClub
Bankcard
ChinaUnionPay

### TenderSubtype.DebitCard class—this is a static class that defines constants for the most popular debit card subtypes.

Constants

STAR
Interlink
Maestro
NYCE
Pulse
AFFN
ACCEL
MAC
CU24
Shazam
Jeanie
AlaskaOption

### TenderType Enum—this is a static class that defines constants for the most popular tender types.

Values

Check
CreditCard
DebitCard
StoredValueCard
ElectronicBenefitsTransferCard

### TransactionAuthorizationData class—this class shows the transaction authorization data.

Members

### Public Properties:

| Property | Type | Description |
|---|---|---|
| AccountData | AccountData | Gets the account data such as: cardholder name, |
| | object | masked account number, etc. |
| ApprovalCode | String | Gets the approval code |
| ApprovedAmount | Decimal | Gets the approved amount |
| AvailableBalance | Decimal | Gets the available balance |
| CustomData | Collections.Generic. | Gets an object that contains custom data |
| | Dictionary | |
| | <string,object> | |
| TenderSubType | String | Gets the tender subtype (such as: AMEX, |
| | | Visa, Master cards, etc. - for credit cards |
| | | for example) |
| TenderType | TenderType | Gets the tender type (whether it is: credit |
| | Enum | cards, check, debit card, etc.) |
| TransactionId | String | Gets the transaction id that is generated |
| | | by the Payment Service Provider. |
| VerificationCode | String | Gets the verification code |

### Constructors:

public TransactionAuthorization Data(string transactionId)
public TransactionAuthorization Data(string transactionId, string approvalCode)
public TransactionAuthorizationData(string transactionId, string approvalCode, decimal approvedAmount)
public TransactionAuthorizationData(string transactionId, string approvalCode, decimal approvedAmount, string verificationCode)
public TransactionAuthorizationData(string transactionId, string approvalCode, decimal approvedAmount, string verificationCode,
System.Collections.Generic.Dictionary<string,object>customData)

Methods

### Clone Method—creates a copy of the TransactionAuthorizationData object.

public TransactionAuthorizationData Clone( )
   TransactionTotals class—provides information about a previously committed transaction payment totals to the application. This information will come from the processor's back-end and will be delivered to the application by the payment object.

Members

### Public Properties:

| Property | Type | Description |
|---|---|---|
| TransactionCount | Int | Gets the total number of transactions |
| | | committed |
| ApprovedCount | Int | Gets the total number of approved |
| | | transactions |
| DeclinedCount | Int | Gets the total number of declined |
| | | transactions |
| SettledCount | Int | Gets the total number of settled transactions |
| VoidCount | Int | Gets the total number of void transactions |
| PendingCount | Int | Gets the total number of void transactions |
| FailedCount | Int | Gets the total number of failed transactions |
| ApprovedAmount | Decimal | Gets the total amount of approved |
| | | transactions |
| SettledAmount | Decimal | Gets the total amount of settled transactions |
| PendingAmount | Decimal | Gets the total amount of pending transactions |

### UnitOfMeasure Enum—an Enum that shows the different units of measure.

### NOTE: the list in the actual enum is very comprehensive and contains units of measure, the values shown below are just a few examples of what is in that list.

Values

Acre
Activity
. . .

UniversalProcessingService class—the interface class between the service provider and application. This interface is used when the application needs to process payments synchronously or asynchronously (so, more asynchronous operations can be initiated before the previous ones finish).
Exceptions thrown:
Most of the methods described below return PaymentResultData object which contains the result of the transaction. The “Result” property shows the actual result of the operation, for example the result might be “Approved” or “Decline”, etc.
In some cases though, the operations fail to complete and return a proper result due to a failure (that can be a communication failure, a system failure, etc.). In such cases, the operations will throw an exception. An example of this would be if while an Authorize operation is being committed, the communication with the service provider fails, an exception is thrown in this case.

Members

### Public Properties:

| Property | Type | Description |
|---|---|---|
| CustomData | Collections.Generic.Dictionary | Gets the container for |
| | <string,object> | any additional custom |
| | | data that application may |
| | | pass to the payment |
| | | object. |

### Public Methods:

| | |
|---|---|
| Authorize | Performs an authorization operation for the given |
| | tender and payment amount. In general, this operation |
| | reserves the given amount on the payee's account |
| | associated with the tender for future settlement. |
| Charge | Performs a charge transaction for the given tender and |
| | payment amount. |
| Credit | Credits payee's account associated with the tender with |
| | the given amount. |
| Refund | Refunds the given amount back to the payee based on the |
| | previous charge transaction. |
| Settle | Settles the given amount based on the previously |
| | completed authorization transaction. |
| Void | Voids the transaction |
| Close | Disposes the PaymentProcessor object |
| VerifyAddress | Verifies the address of the payee. |
| StartNewBatch | Creates a new batch |
| StartBatchSettlement | Starts settling a batch of transactions |
| CommitBatchSettlement | Ends settling a batch of transactions |
| CancelBatchSettlement | Cancels a batch settlement |
| GetCurrentBatchId | Retrieves the current Batch Id |
| InquireAccountData | Retrieves tender specific data such as remaining |
| | balance, etc. |
| InquireTransaction | Lets the application query for a transaction |
| InquireTransactions | Lets the application query for several transactions |
| InquireTotals | Lets the application query for transaction totals |
| BeginAuthorize | Starts an asynchronous authorization operation for the |
| | given tender and payment amount. In general, this |
| | operation reserves the given amount on the payee's |
| | account associated with the tender |
| EndAuthorize | Ends an asynchronous authorization operation. |
| BeginCharge | Starts an asynchronous charge transaction for the |
| | given tender and payment amount. |
| EndCharge | Ends an asynchronous charge transaction. |
| BeginCredit | Starts an asynchronous credit transaction to credit the |
| | payee's account associated with the tender with the |
| | given amount. |
| EndCredit | Ends an asynchronous credit transaction. |
| BeginRefund | Starts an asynchronous refund transaction to refund |
| | the given amount back to the payee based on the |
| | previous charge transaction. |
| EndRefund | Ends an asynchronous refund transaction. |
| BeginSettle | Starts an asynchronous settle transaction to settle the |
| | given amount based on the previously completed |
| | authorization transaction |
| EndSettle | Ends an asynchronous settle transaction. |
| BeginVoid | Starts voiding a transaction |
| EndVoid | Ends a void transaction |
| BeginStartNewBatch | Starts a new batch for settlement |
| EndStartNewbatch | Ends starting a new batch for settlement. |
| BeginStartBatchSettlement | Starts settling a batch of transactions |
| EndStartBatchSettlement | Ends settling a batch of transactions |
| BeginCommitBatchSettlement | Submits settling a batch of transactions |
| EndCommitBatchSettlement | Ends the submission of settling a batch of transactions |
| BeginCancelBatchSettlement | Cancels a batch settlement |
| EndCancelBatchSettlement | Ends the Cancelation operation of a batch settlement |
| BeginTransferBalance | Starts transferring a balance between two tenders |
| EndTransferBalance | Ends transferring a balance between two tenders |
| Open | Opens the communication with the appropriate |
| | payment processing interface class |
| Close | Closes the communication with the appropriate |
| | payment processing interface class |
| CustomOperation | This is a custom operation that takes operationCode |
| | as a parameter as well as a data object. It returns |
| | PaymentResultData that has the result of the |
| | operation. |
| GetConfigurationProperty | Lets the application get the configuration property |
| CanProcess | Figures out whether or not the payment service can |
| | process a tender |

### Constructors:

protected UniversalProcessingService( )

Methods
Authorize Method—performs an authorization operation for the given tender and payment amount. In general, this operation reserves the given amount on the payee's account associated with the tender for future settlement.
public PaymentResultData Authorize(Tender tender, PaymentData amount, String referenceId);
public PaymentResultData Authorize(Tender tender, PaymentData amount, String referenceId, BasketData basket);
public PaymentResultData Authorize(Tender tender, PaymentData amount, String referenceId, String offlineApprovalCode);
public PaymentResultData Authorize(Tender tender, PaymentData amount, String referenceId, BasketData basket, String offlineApprovalCode);

### Parameters:

1) tender
Container object that specifies has information about the payment tender

2) amount
Container object that has information about the payment amount

3) referenceId
String that specifies the reference ID of the transaction

4) basket
Container object that has information about the items for which the payment is being made.

5) offlineApprovalCode
The approval code received when doing offline authorization

### Returns

PaymentResultData object with the result of the operation.
Charge Method—performs a charge transaction for the given tender and payment amount.
public PaymentResultData Charge(Tender tender, PaymentData amount, String referenceId);
public PaymentResultData Charge(Tender tender, PaymentData amount, String referenceId, BasketData basket);
public PaymentResultData Charge(Tender tender, PaymentData amount, String referenceId,
String offlineApprovalCode);
public PaymentResultData Charge(Tender tender, PaymentData amount, String referenceId, BasketData basket, String offlineApprovalCode);

### Parameters:

1) tender
Container object that specifies has information about the payment tender

2) amount
Container object that has information about the payment amount

3) referenceId
String that specifies the reference ID of the transaction

4) basket
Container object that has information about the items for which the payment is being made.

### Returns

PaymentResultData object with the result of the operation.
Credit Method—credits payee's account associated with the tender with the given amount. If there was a prior charge/settle transaction, this method will perform a linked-Credit by passing the prior transaction information available to the service provider (through the TransactionAuthorizationData parameter). In the case of no prior charge or settle transaction, then the application uses this method to perform a non-linked Credit by just crediting a certain amount to the payee's account associated with a tender.
   This method is also used to Activate a Gift Card or a Stored Value Card with any or no amount. The gift or stored value card can come without pre-defined monetary value, in this case, the application can activate the card and credit a certain amount to it using the Credit method. If the card comes with a pre-defined monetary value, the application can just activate the card without adding any money value to it by calling the Credit method indicating zero amount.
public abstract PaymentResultData Credit(Tender tender, PaymentData amount, String referenceId, BasketData basket, TransactionAuthorizationData authorizationData);
public virtual PaymentResultData Credit(Tender tender, PaymentData amount, String referenceId);
public virtual PaymentResultData Credit(Tender tender, PaymentData amount, String referenceId, BasketData basket);
public virtual PaymentResultData Credit(PaymentData amount, String referenceId, TransactionAuthorization Data authorizationData);
public virtual PaymentResultData Credit(PaymentData amount, String referenceId, BasketData basket, TransactionAuthorizationData authorizationData);
public virtual PaymentResultData Credit(Tender tender, PaymentData amount, String referenceId; TransactionAuthorizationData authorization Data);

### Parameters:

1) tender
Container object that specifies has information about the payment tender

2) amount
Container object that has information about the payment amount

3) referenceId
String that specifies the reference ID of the transaction

4) basket
Container object that has information about the items for which the payment is being made.

5) authorizationData
the TransactionAuthorizationData object

### Returns

PaymentResultData object with the result of the operation.
Settle Method—settles the given amount based on a previously completed authorization transaction where the approval code is available.
public virtual PaymentResultData Settle(PaymentData amount, string referenceId, TransactionAuthorizationData authorizationData)
public abstract PaymentResultData Settle(Tender tender, PaymentData amount, string referenceId, TransactionAuthorizationData authorization Data)

### Parameters:

1) tender
Container object that specifies has information about the payment tender

2) amount
Container object that has information about the payment amount

3) referenceId
String that specifies the reference ID of the transaction

4) basket
Container object that has information about the items for which the payment is being made.

5) authorizationData
the TransactionAuthorizationData object

### Returns

PaymentResultData object with the result of the operation.

### Void Method—voids a previously authorized transaction.

public virtual PaymentResultData Void(TransactionAuthorizationData authorizationData)
public abstract PaymentResultData Void(Tender tender, TransactionAuthorizationData authorizationData)
public abstract PaymentResultData Void (string referenceId, PaymentData amount)
   Note: The last overload is used in cases such as the following: If a payment object (PO) lost connection to the back-end and doesn't know whether or not the transaction got approved. Nor does it have a transaction ID.

### Parameters:

1) amount
Container object that has information about the payment amount

2) tender
The tender object

3) authorizationData
the TransactionAuthorizationData object

### Returns

PaymentResultData object with the result of the operation.

### Open Method—opens the UniversalProcessingService object

public void Open ( )

### Parameters:

None

### Returns

None

### Close Method—disposes the UniversalProcessingService object

public override void Close( )

### Parameters:

None

### Returns

None

### ValidateAddress Method—validates the address of the payee.

public virtual PaymentResultData VerifyAddress(Tender tender)

### Parameters:

1) tender
The tender object

### Returns

PaymentResultData object with the result of the operation.
InquireAccountData Method—retrieves data about a tender account. This method can be used when information such as remaining balance is needed for a tender.
public virtual PaymentResultData InquireAccountData (Tender tender, Currency currency)

### Parameters:

1) tender
The tender object

2) currency
The currency object

### Returns

PaymentResultData object with the result of the operation.

### InquireTransaction Method—lets the application query for a transaction

### Constructors:

public abstract PaymentTransaction InquireTransaction(string transactionId);
public abstract PaymentTransaction InquireTransaction(string approvalCode, decimal totalAmount);
public abstract PaymentTransaction InquireTransaction( DateTime date, string transactionId);
public abstract PaymentTransaction InquireTransaction( DateTime date, string approvalCode, decimal totalAmount);

### InquireTransactions Method

Lets the application query for several transactions

### Constructors:

public abstract ReadOnlyCollection<PaymentTransaction>InquireTransactions( );
public abstract ReadOnlyCollection<PaymentTransaction>InquireTransactions(TenderType tenderType);
public abstract ReadOnlyCollection<PaymentTransaction>InquireTransactions(TenderType tenderType, PaymentTransactionType transactionType);
public abstract ReadOnlyCollection<PaymentTransaction>InquireTransactions(PaymentTransactionStatus transactionStatus);
public abstract ReadOnlyCollection<PaymentTransaction>InquireTransactions(TenderType tenderType, PaymentTransactionStatus transactionStatus);
public abstract ReadOnlyCollection<PaymentTransaction>InquireTransactions(TenderType tenderType, PaymentTransactionType transactionType, PaymentTransactionStatus transactionStatus);
public abstract ReadOnlyCollection<PaymentTransaction>InquireTransactions(DateTime from, DateTime to);
public abstract ReadOnlyCollection<PaymentTransaction>InquireTransactions(DateTime from, DateTime to, TenderType tenderType);
public abstract ReadOnlyCollection<PaymentTransaction>InquireTransactions(DateTime from, DateTime to, TenderType tenderType, PaymentTransactionType transactionType);
public abstract ReadOnlyCollection<PaymentTransaction>InquireTransactions(DateTime from, DateTime to, PaymentTransactionStatus transactionStatus);
public abstract ReadOnlyCollection<PaymentTransaction>InquireTransactions(DateTime from, DateTime to, TenderType tenderType, PaymentTransactionStatus transactionStatus);
public abstract ReadOnlyCollection<PaymentTransaction>InquireTransactions(DateTime from, DateTime to, TenderType tenderType,PaymentTransactionType transactionType, PaymentTransactionStatus transactionStatus);

### InquireTotals Method—lets the application query for transaction totals

### Constructors:

public abstract TransactionTotals InquireTotals( );
public abstract TransactionTotals InquireTotals(TenderType tenderType);
public abstract TransactionTotals InquireTotals(DateTime from, DateTime to);
public abstract TransactionTotals InquireTotals(DateTime from, DateTime to, TenderType tenderType);

### StartNewBatch Method—creates a new batch of transactions (to be settled later).

public virtual void StartNewBatch( )

### Parameters:

None

### Returns

None

### StartBatchSettlement Method—starts settling a batch of transactions.

Here is an example of the steps how an application would use this method: When the application is ready to settle the transactions authorized previously (that were added to a batch), the application calls StartBatchSettlement. Then individual Settle calls are done on each transaction in that batch. When the application is done calling Settle for the transactions it wants in the batch, it can now submit the settle requests to the back-end service provider by calling CommitBatchSettlement. Or, instead of calling CommitBatchSettlement, the application can choose to cancel the batch settlement by calling CancelBatchSettlement.
public abstract void StartBatchSettlement( )
public abstract void StartBatchSettlement(string batchId)

### Parameters:

1) batchId
shows the batch number that needs to be settled.

### Returns

None

### CommitBatchSettlement Method—commits settling a batch of transactions.

Here is an example of the steps how an application would use this method: When the application is ready to settle the transactions authorized previously (that were added to a batch), the application calls StartBatchSettlement. Then individual Settle calls are done on each transaction in that batch. When the application is done calling Settle for the transactions it wants in the batch, it can now submit the settle requests to the back-end service provider by calling CommitBatchSettlement. Or, instead of calling CommitBatchSettlement, the application can choose to cancel the batch settlement by calling CancelBatchSettlement.
public abstract PaymentResultData CommitBatchSettlement ( );

### Parameters:

None

### Returns

PaymentResultData object with the result of the operation.

### CancelBatchSettlement Method—cancels a batch settlement.

Here is an example of the steps how an application would use this method: When the application is ready to settle the transactions authorized previously (that were added to a batch), the application calls StartBatchSettlement. Then individual Settle calls are done on each transaction in that batch. When the application is done calling Settle for the transactions it wants in the batch, it can now submit the settle requests to the back-end service provider by calling CommitBatchSettlement. Or, instead of calling CommitBatchSettlement, the application can choose to cancel the batch settlement by calling CancelBatchSettlement.
public abstract void CancelBatchSettlement( )

### Parameters:

None

### Returns

None

### GetCurrentBatchld Method—gets the current batch Id.

public string GetCurrentBatchld ( );

### Parameters:

None

### Returns

String that is the Batch Id
BeginAuthorize Method—starts an asynchronous authorization operation for the given tender and payment amount. In general, this operation reserves the given amount on the payee's account associated with the tender for future settlement.
public System.IAsyncResult BeginAuthorize(Tender tender, PaymentData amount, String referenceId, BasketData basket, AsyncCallback callback, Object state );
public System.IAsyncResult BeginAuthorize(Tender tender, PaymentData amount, String referenceId, AsyncCallback callback, Object state);

### Parameters:

1) tender
Container object that specifies has information about the payment tender

2) amount
Container object that has information about the payment amount

3) referenceId
String that specifies the reference ID of the transaction

4) basket
Container object that has information about each item for which the payment is being made.

5) callback
References the callback method to be called when the asynchronous operation is completed.

6) state
An object holding the state of the transaction

### Returns

System.IAsyncResult object which represents the status of an asynchronous operation

### EndAuthorize Method ends an asynchronous authorization operation.

public PaymentResultData EndAuthorize (System.IAsyncResult asyncResult)

### Parameters:

1) asyncResult
Object returned by BeginAuthorize.

### Returns:

System.IAsyncResult object which represents the status of an asynchronous operation
BeginCharge Method—starts an asynchronous charge transaction for the given tender and payment amount.
public System.IAsyncResult BeginCharge(Tender tender, PaymentData amount, String referenceId, BasketData basket, AsyncCallback callback, Object state);
public System.IAsyncResult BeginCharge(Tender tender, PaymentData amount, String referenceId, AsyncCallback callback, Object state);

### Parameters:

1) tender
Container object that specifies has information about the payment tender

2) amount
Container object that has information about the payment amount

3) referenceId
String that specifies the reference ID of the transaction

4) basket
Container object that has information about the items for which the payment is being made.

5) callback
References the callback method to be called when the asynchronous operation is completed.

6) state
An object holding the state of the transaction

### Returns

System.IAsyncResult object which represents the status of an asynchronous operation

### EndCharge Method—ends an asynchronous Charge operation.

public PaymentResultData EndCharge(System.IAsyncResult asyncResult)

### Parameters:

1) asyncResult
Object returned by BeginCharge.

### Returns:

System.IAsyncResult object which represents the status of an asynchronous operation
BeginCredit Method—starts an asynchronous credit transaction to credit the payee's account associated with the tender with the given amount. Does not require a previous charge transaction.
public System.IAsyncResult BeginCredit(Tender tender, PaymentData amount, String referenceId, BasketData basket, AsyncCallback callback, Object state);
public System.IAsyncResult BeginCredit(Tender tender, PaymentData amount, String referenceId, AsyncCallback callback, Object state);

### Parameters:

1) tender
Container object that specifies has information about the payment tender

2) amount
Container object that has information about the payment amount

3) referenceId
String that specifies the reference ID of the transaction

4) basket
Container object that has information about the items for which the payment is being made.

5) callback
References the callback method to be called when the asynchronous operation is completed.

6) state
An object holding the state of the transaction

### Returns

System.IAsyncResult object which represents the status of an asynchronous operation

### EndCredit Method

Ends an asynchronous Credit operation.
public PaymentResultData EndCredit(System.IAsyncResult asyncResult)

### Parameters:

1) asyncResult
Object returned by BeginCredit.

### Returns:

System.IAsyncResult object which represents the status of an asynchronous operation

### BeginRefund Method

Starts an asynchronous refund transaction to refund the given amount back to the payee based on a previous charge or settle transaction.
public abstract System.IAsyncResult BeginRefund(Tender tender, PaymentData amount, string referenceId, TransactionAuthorizationData authorization Data, System.AsyncCallback callback, object state)
public abstract System.IAsyncResult BeginRefund(PaymentData amount, string referenceId, TransactionAuthorizationData authorization Data, System.AsyncCallback callback, object state)

### Parameters:

1) tender
Container object that specifies has information about the payment tender

2) amount
Container object that has information about the payment amount

3) referenceId
String that specifies the reference ID of the transaction

4) authorizationData
the TransactionAuthorizationData object

5) callback
References the callback method to be called when the asynchronous operation is completed.

6) state
An object holding the state of the transaction

### Returns

System.IAsyncResult object which represents the status of an asynchronous operation

### EndRefund Method—ends an asynchronous Refund operation.

public PaymentResultData EndRefund(System.IAsyncResult asyncResult)

### Parameters:

1) asyncResult
Object returned by BeginRefund.

### Returns:

System.IAsyncResult object which represents the status of an asynchronous operation
BeginSettle Method—starts an asynchronous settle transaction to settle the given amount based on a previously completed authorization transaction where the approval code is available.
public abstract System.IAsyncresult BeginSettle(Tender tender, PaymentData amount, string referenceId, TransactionAuthorizationData authorizationData, System.AsyncCallback callback, object state)
public abstract System.IAsyncResult BeginSettle(PaymentData amount, string referenceId, TransactionAuthorizationData authorization Data, System.AsyncCallback callback, object state)

### Parameters:

1) tender
Container object that specifies has information about the payment tender

2) amount
Container object that has information about the payment amount

3) referenceId
String that specifies the reference ID of the transaction

4) authorizationData
the TransactionAuthorizationData object

5) callback
References the callback method to be called when the asynchronous operation is completed.

6) state
An object holding the state of the transaction

### Returns

System.IAsyncResult object which represents the status of an asynchronous operation

### EndSettle Method—ends an asynchronous Refund operation.

public PaymentResultData EndSettle(System.IAsyncResult asyncResult)

### Parameters:

1) asyncResult
Object returned by BeginSettle.

### Returns:

System.IAsyncResult object which represents the status of an asynchronous operation
BeginVoid Method—starts an asynchronous Void transaction to void a previously authorized transaction.
public abstract System.IAsyncResult BeginVoid(TransactionAuthorization Data authorizationData, System.AsyncCallback callback, object state)
public abstract System.IAsyncResult BeginVoid(.Tender tender, TransactionAuthorization Data authorizationData, System.AsyncCallback callback, object state)
public abstract System.IAsyncResult BeginVoid(string referenceId, PaymentData amount, System.AsyncCallback callback, object state)

### Parameters:

1) authorizationData
the TransactionAuthorizationData object

2) callback
AsyncCallBack

3) state
object showing the state

4) referenceId
string showing the reference Id

5) amount
object showing the payment amount details

### Returns:

### System.IAsyncResult object which represents the status of an asynchronous operation

### EndVoid Method—ends an asynchronous Void operation.

public PaymentResultData EndVoid(System.IAsyncResult asyncResult)

### Parameters:

1) asyncResult
Object returned by BeginVoid.

### Returns:

System.IAsyncResult object which represents the status of an asynchronous operation

### BeginStartNewBatch Method—starts a new batch for settlement

public abstract System.IAsyncResult BeginStartNewBatch(System.AsyncCallback callback, object state)

### Parameters:

1) callback
AsyncCallBack

2) state
object showing the state

### Returns:

### System.IAsyncResult object which represents the status of an asynchronous operation

EndBeginStartNewBatch Method—ends an asynchronous BeginStartNewBatch operation.
public PaymentResultData EndBeginStartNewBatch(System.IAsyncResult asyncResult)

### Parameters:

1) asyncResult
Object returned by BeginStartNewBatch.

### Returns:

System.IAsyncResult object which represents the status of an asynchronous operation

### BeginStartBatchSettlement Method—starts settling a batch of transactions.

public abstract System.IAsyncResult BeginStartBatchSettlement(System.AsyncCallback callback, object state)
public abstract System.IAsyncResult BeginStartBatchSettlement(string batchId, System.AsyncCallback callback, object state)
public abstract System.IAsyncResult BeginVoid(Tender tender, TransactionAuthorization Data authorization Data, System.AsyncCallback callback, object state)

### Parameters:

1) callback
AsyncCallBack

2) state
object showing the state

3) tender
The tender object

4) authorizationData
the TransactionAuthorizationData object

### Returns:

### System.IAsyncResult object which represents the status of an asynchronous operation

EndBeginStartBatchSettlement Method—ends an asynchronous BeginStartNewSettlement operation.
public PaymentResultData EndBeginStartBatchSettlement(System.IAsyncResult asyncResult)

### Parameters:

1) asyncResult
Object returned by BeginStartBatchSettlement.

### Returns:

System.IAsyncResult object which represents the status of an asynchronous operation

### BeginCommitBatchSettlement Method—commits settling a batch of transactions.

public abstract System.IAsyncResult
BeginCommitBatchSettlement(System.AsyncCallback callback, object state)

### Parameters:

1) callback
AsyncCallBack

2) state
object showing the state

### Returns:

### System.IAsyncResult object which represents the status of an asynchronous operation

EndBeginCommitBatchSettlement Method—ends an asynchronous BeginCommitBatchSettlement operation.
public PaymentResultData EndBeginCommitBatchSettlement(System.IAsyncResult asyncResult)

### Parameters:

1) asyncResult
Object returned by BeginCommitBatchSettlement.

### Returns:

System.IAsyncResult object which represents the status of an asynchronous operation

### BeginCancelBatchSettlement Method—cancels a batch settlement.

public abstract System.IAsyncResult
BeginCancelBatchSettlement(System.AsyncCallback callback, object state)

### Parameters:

1) callback
AsyncCallBack

2) state
object showing the state

### Returns:

### System.IAsyncResult object which represents the status of an asynchronous operation

EndBeginCancelBatchSettlement Method ends an asynchronous BeginCancelBatchSettlement operation.
public PaymentResultData EndBeginCancelBatchSettlement(System.IAsyncResult asyncResult)

### Parameters:

1) asyncResult
Object returned by BeginCancelBatchSettlement.

### Returns:

System.IAsyncResult object which represents the status of an asynchronous operation
BeginTransferBalance Method—starts an asynchronous settle transaction to settle the given amount based on the previously completed authorization transaction public virtual System.IAsyncResult BeginTransferBalance(Tender from, Tender to, System.AsyncCallback callback, object state)
   public virtual System.IAsyncResult BeginTransferBalance(Tender from, Tender to, System.DateTime expiration, System.AsyncCallback callback, object state)

### Parameters:

1) from
The tender object from which the balance is transferred from

2) to
The tender object from which the balance is transferred to

3) expiration
In the case of a replacement transaction, the expiration date represents the expiration date of the old card. Returned only in response of replacement card transaction

4) callback
AsyncCallBack

5) state
object showing the state

### Returns

System.IAsyncResult object which represents the status of an asynchronous operation
EndBeginTransferBalance Method—ends an asynchronous BeginTransferBalance operation.
public PaymentResultData EndBeginTransferBalance(System.IAsyncResult asyncResult)

### Parameters: 1) asyncResult

Object returned by BeginTransferBalance.

### Returns:

System.IAsyncResult object which represents the status of an asynchronous operation

### Payment.PaymentObject Namespace

PaymentAssemblyAttribute Class

### This class shows the payment assembly attribute.

### Members

### Public Properties:

| Property | Type | Description |
|---|---|---|
| PaymentObjectProvider | String | A String meant to identify the |
| | | PO writer. In most cases that |
| | | will be the service provider. |
| | | There may be other cases where, |
| | | for example, generic payment objects |
| | | (POs) are written by API vendor |
| | | in which the service provider will not |
| | | be the same as PO writer (so, in |
| | | this case the PaymentObjectProvider |
| | | will be API vendor). |

### Constructors:

public PaymentAssemblyAttribute(string paymentObjectProvider);

### Parameters:

1) paymentObjectProvider
A String meant to identify the PO writer. In most cases that will be the service provider. There may be other cases where, for example, generic payment objects (POs) are written by Payment API vendor in which the service provider will not be the same as PO writer (so, in this case the paymentObjectProvider will be Payment API vendor).

### PaymentObjectAttribute class—this class contains the payment object attributes.

This attribute marks a .NET class as a payment object.

### Members

### Public Properties:

| Property | Type | Description |
|---|---|---|
| Com- | PaymentObjectCompatibilities | A |
| patibility | | PaymentObjectCompatibilities |
| | | object that shows one of the |
| | | following levels of interface |
| | | capabilities: Desktop, |
| | | Mobile and |
| | | DesktopAndMobile exception |
| De- | String | A String showing the |
| scription | | description of the payment |
| | | object. |
| Name | String | A String showing the |
| | | payment object name. |

### Constructors:

public PaymentObjectAttribute(string name, string description, PaymentObjectCompatibilities compatibility)

### Parameters:

1) name
A String showing the payment object name.

2) description
A String showing the description of the payment object.

3) compatibility
A PaymentObjectCompatibilities object that shows one of the following levels of interface capabilities: Desktop, Mobile and DesktopAndMobile exception

SupportedTenderTypeAttribute class—shows the supported tender types/subtypes attributes.

### Members

### Public Properties:

| Property | Type | Description |
|---|---|---|
| Type | TenderType | Showing tender type |
| Subtype | String | Showing tender subtype |

### Constructors:

public SupportedTenderTypeAttribute(TenderType type)
public SupportedTenderTypeAttribute(TenderType type, string subtype)

### Payment.Restaurant Namespace

RestaurantPaymentData class—this class is derived from the PaymentData class.
This class provides additional information on the payment amount that the Restaurant businesses can use to report/save for each consumer's payment.

### Members

### Public Properties

| Property | Type | Description |
|---|---|---|
| Gratuity | Decimal | Decimal: amount of tip |

### Constructors:

public RestaurantPaymentData(Decimal gratuity);

### Payment.Lodging Namespace

LodgingBasketItem class—this class is derived from the BasketItem class. This class provides additional basket information specific to a Lodging business.

### Members

### Public Properties

| Property | Type | Description |
|---|---|---|
| ChargeCategory | LodgingExtraCharge | Details the extra charges that |
| | | might be incurred in a |
| | | lodging stay. |

### Constructors:

public LodgingBasketItem(Lodging.LodgingExtraCharge chargeCategory, string description, string productCode, decimal unitPrice, decimal quantity, UnitOfMeasure unitOfMeasure, decimal discount, decimal taxRate, decimal taxAmount)
public LodgingBasketItem(Lodging.LodgingExtraCharge chargeCategory, string description, string productCode, decimal unitPrice, decimal quantity, decimal taxRate, decimal taxAmount)
public LodgingBasketItem(Lodging.LodgingExtraCharge chargeCategory, string description, string productCode, decimal unitPrice, decimal quantity)
public LodgingBasketItem(Lodging.LodgingExtraCharge chargeCategory, string description, string productCode, decimal unitPrice, decimal quantity, UnitOfMeasure unitOfMeasure)
public LodgingBasketItem(Lodging.LodgingExtraCharge chargeCategory, string description, decimal unitPrice, decimal quantity, decimal taxRate, decimal taxAmount)
public LodgingBasketItem(Lodging.LodgingExtraCharge chargeCategory, string description, decimal unitPrice, decimal quantity)
public LodgingBasketItem(Lodging.LodgingExtraCharge chargeCategory, string description, decimal unitPrice, decimal quantity, UnitOfMeasure unitOfMeasure)

LodgingExtraCharge Enum—shows the extra charges that the customer incurred during the lodging stay.

Values
Telephone
Laundry
Minibar
Movie
Food
Parking
BusinessCenter
HealthClub
Other

LodgingPaymentData class—This class is derived from the PaymentData class.
This class provides additional information on the payment amount that the Lodging businesses can use to report/save for each consumer's payment.

### Members

### Public Properties

| Property | Type | Description |
|---|---|---|
| CheckinDate | DateTime | DateTime: Gets the check-in date |
| CheckoutDate | DateTime | DateTime: Gets the check-out date |
| Folio | String | String: Gets the folio numer/ID |
| StayDuration | Int | Int: Gets the duration of stay (will be |
| | | in hours not days) |
| RoomRate | Decimal | Decimal: Gets the room rate |
| NoShow | Bool | Boolean: showing whether or |
| | | not the payee used the room |
| ExtraCharges | Decimal | Decimal: amount of extra charges |

### Constructors:

public LodgingPaymentData(Decimal amount, String folio, DateTime checkInDate, DateTime checkOutDate, Int32 stayDuration, Decimal roomRate)
public LodgingPaymentData(Decimal amount, String folio, DateTime checkInDate, DateTime checkOutDate, Int32 stayDuration, Decimal roomRate, Decimal extraCharges)

### Parameters:

1) amount
Decimal showing the payment amount

2) folio
String showing the folio

3) checkInDate
DateTime showing the checkin date

4) checkOutDate
DateTime showing the checkout date

5) stayDuration
Int showing the duration of stay

6) roomRate
Decimal showing the room rate

7) extraCharges
Decimal reflecting the value of the extra charges. Some examples of extra charges are: Telephone, Laundry, Minibar, Movie, Food, Parking, BusinessCenter, HealthClub, etc.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing device, a system, comprising, a payment abstraction layer including payment-related methods that are called by an application program to process payment-related input data, the payment abstraction layer further configured to interface with payment service providers for sending payment data to a selected payment service provider's payment processor in a protocol and message format required by that payment service provider payment processor.

2. The system of claim 1 wherein the payment abstraction layer instantiates a payment object corresponding to the selected payment service provider for calling by the application program to send the payment data.

3. The system of claim 2 further comprising a payment service that comprises a configuration of a payment object for a particular merchant.

4. The system of claim 1 wherein the payment-related input data is received at a terminal, a point-of-sale personal computer, or an electronic commerce site.

5. The system of claim 1 wherein the payment processor comprises a credit card processor, a debit card processor, a check processor, or a gift card processor.

6. The system of claim 1 wherein the payment abstraction layer includes at least one payment object base class.

7. The system of claim 1 wherein the payment abstraction layer includes object management functionality, helper functionality, or both object management functionality and helper functionality.

8. The system of claim 1 wherein the payment abstraction layer includes an enumeration-related interface by which the application program locates a payment service for selection.

9. The system of claim 1 wherein the payment-related methods that are called by the application program includes a set of at least some methods that are independent of any tender type.

10. The system of claim 9 wherein the set includes an authorize method, a charge method, a credit method, a refund method, a settle method, or a void method, or any combination thereof.

11. In a computing device, a system, comprising, a set of payment-related methods that are called by an application program to process payment-related input data, and a hierarchy of tender classes in which one class encapsulates data for different types of tenders.

12. The system of claim 11 wherein the hierarchy of tender classes includes a tender class that is hierarchically above a payment card class and a check-related class.

13. The system of claim 12 wherein the hierarchy of tender classes includes a direct debit/credit class and a check class that are each hierarchically below the check-related class.

14. In a computing device, a system, comprising, a payment abstraction layer including payment-related methods that are called by an application program, including at least one enumeration-related method that provides a mechanism for the application program to discover each payment service configured on the system, and at least one object creation method that provides a mechanism for the application program to instantiate a payment object corresponding to a selected payment service.

15. The system of claim 14 wherein the payment object provides a generic processing service object having methods capable of processing a plurality of payment instrument types.

16. The system of claim 15 wherein the generic processing service object includes methods for synchronous processing of payments, or methods for asynchronous processing of payments, or both methods for synchronous processing of payments and methods for asynchronous processing of payments.

17. The system of claim 14 wherein the payment abstraction layer includes an enumeration-related method for getting a payment service that matches a required payment service name, an enumeration-related method for getting a default payment service that supports a specified tender type, an enumeration-related method for getting available payment services, or an enumeration-related method for getting any payment services that conform to a specified criterion or set of criteria, or any combination of these enumeration-related methods.

18. The system of claim 14 wherein the payment abstraction layer includes at least one payment object base class.

19. The system of claim 14 wherein the payment abstraction layer includes object management functionality, helper functionality, or both object management functionality and helper functionality.

20. The system of claim 14 wherein the payment abstraction layer further comprises a hierarchy of tender classes in which one class encapsulates data for different types of tenders.
